(19) United States
(12) Patent Application Publication
(10) Pub. No.: US 2011/0213959 A1
(43) Pub. Date: Sep. 1, 2011

(54) METHODS, APPARATUSES, SYSTEM AND RELATED COMPUTER PROGRAM PRODUCT FOR PRIVACY-ENHANCED IDENTITY MANAGEMENT

(75) Inventors: MiklosTamas Bodi, Budapest (HU); Gabor Marton, Budapest (HU); Silke Holtmanns, Klaukkala (FI)

(73) Assignee: NOKIA SIEMENS NETWORKS OY, ESPOO (FI)

(21) Appl. No.: 13/128,443

(22) PCT Filed: Nov. 10, 2008
(86) PCT No.: PCT/EP2008/065245

§ 371 Date: May 10, 2011

(51) Int. Cl. H04L 9/12; G06F 15/16

(52) U.S. Cl. 713/155; 709/203

(57) ABSTRACT

A method and related apparatus include the steps of registering, from a client at a service providing network entity, first client-related identity information and, from the client at an identity providing network entity, second client-related identity information being different from the first client-related identity information and being generated based on the first client-related identity information. Key information is a secret of the client and identity information is related to the service providing network entity. A second method and related apparatus include the step of determining, at a service providing network entity, the first client-related identity information based on the second client-related identity information being received from the identity providing entity. Finally, a third method and related apparatus include the step of authenticating, towards the service providing network entity, the second client-related identity information being received from the client.

### FIELD OF THE INVENTION

Examples of the present invention relate to privacy-enhanced identity management. More specifically, the examples of the present invention relate to methods, apparatuses, a system and a related computer program product for privacy-enhanced identity management. Examples of the present invention may be applicable to single sign-on of a client at a service provider (SP).

### BACKGROUND

So-called single sign-on is a key element of identity management solutions and an important cornerstone of web service security. By means of single sing-on, a client (e.g. end users) is enabled to seamlessly sign on to different services by authenticating the client only once.

FIG. 1A shows the principle underlying single sign-on in a simplified fashion, i.e. only showing the logical path of the main messages (e.g. steps S1 and S2 may be carried out via HTTP redirection). As shown in FIG. 1A, a communication network 100 comprises a client 101 and a core network 102 (not shown). The core network 102 in turn comprises a service provider (SP hereinafter) 1021 and an identity provider (IdP hereinafter) 1022.

The principle shown in FIG. 1A may reside in so-called identity brokering which is an approach to single sign-on. The client 101 does not directly authenticate itself to the SP 1021. Instead, in step S1, an authentication is performed between the client 101 and the IdP 1022. In step S2, the SP 1021 obtains the authentication assertion containing an SP-specific user identifier from the IdP. Finally, in step S3, the SP 1021 provides the personalized service to the client 101 under the assumption that the authentication assertion refers to an existing user at the SP 1021.

As shown in FIGS. 1B to 1G, the principle described above is implemented in different existing architectures, including generic bootstrapping architecture (GBA) as shown in FIG. 1B, liberty identity federation frame work (ID-FF)/security assertion markup language (SAML), as shown in FIG. 1C, OpenID™ as shown in FIG. 1D, Windows Cardspace™ (case of managed cards) as shown in FIG. 1E, central authentication service (CAS), as shown in FIG. 1F, and Kerberos™ as shown in FIG. 1G. Another implementation may reside in remote authentication dial-in user service (RADIUS) authentication.

In all implementations shown in FIGS. 1B to 1G, the client 101 may have slightly different designations, being user equipment (UE) in FIG. 1B, user in FIG. 1C, browser in FIG. 1D, human user using an Internet Explorer® in FIG. 1E, a web browser in FIG. 1F and client in FIG. 1G. Accordingly, also the SP 1021 may have slightly different designations, being network application function (NAF) in FIG. 1B, service provider in FIG. 1C, relying party (RP) in FIGS. 1D and 1E, arbitrary web service and back-end service in FIG. 1F and application server in FIG. 1G. Finally, also the IdP 1022 may have slightly different designations, being bootstrapping server function (BSF) in FIG. 1B, identity provider (IP) in FIGS. 1C and 1E, OpenID™ provider in FIG. 1D, central authentication server in FIG. 1F and Windows® domain controller in FIG. 1G. However, the above varying designations of the client 101, the SP 1021 and the IdP 1022 do not change the principle as described in FIG. 1A.

Furthermore, e.g. according to SlashID™ (http://www.slashid.com), there has been an approach in which when users register with an identity management service, those users create a customized profile. The profile is encrypted, and the password to unlock the profile is kept in the computer of the user. Websites do not have to rely on the identity to authenticate the users. When a user chooses to share a profile with a website, the client of the user decrypts the registration data. The identity management service never issues assertions. Because the data transaction is client based, the identity management service cannot access user data. The user data remain unaffected.

In consideration of the above, according to examples of the present invention, methods, apparatuses, a system and a related computer program product for privacy-enhanced identity management are provided.

According to an example of the present invention, in a first aspect, this object is for example achieved by a method comprising:

registering, from a client at a service providing network entity, first client-related identity information and, from the client at an identity providing network entity, second client-related identity information being different from the first client-related identity information and being generated based on the first client-related identity information, key information being a secret of the client and identity information related to the service providing network entity.

According to further refinements of the example of the present invention as defined under the above first aspect,

the method further comprises deriving one of a shared secret between the client and the service providing entity and a proof of knowledge of the shared secret, and wherein the registering, from the client to service providing network entity, further comprises the one of the shared secret between the client and the service providing entity and the proof of knowledge of the shared secret;

the method further comprises deriving first key information being specific for the service providing network entity and being based on the key information being a secret of the client and the identity information related to the service providing network entity;

the method further comprises generating the second client-related identity information;

the generating further comprises deriving the second client-related identity information based on the first client-related identity information, key information being a secret of the client and identity information related to the service providing network entity;

the deriving is based on one of an encryption function and a cryptographic hash function;

the generating further comprises encrypting the first client-related identity information with the derived first key information in order to obtain the second client-related identity information;

the method further comprises selecting the first client-related identity information;

the method further comprises holding, in the client, the key information being a secret of the client;

the method further comprises depositing the key information being a secret of the client in a trusted network entity;

the method further comprises generating the key information being a secret of the client by a cryptographic function of a biometric characteristic of a user of the client;

the cryptographic function is a cryptographic hash function;

at least one of the registering, the deriving, the encrypting, the selecting, the holding, the depositing and the generating is performed once per existing first client-related identity information and once per loss of the client;

the method further comprises authenticating the client at the identity providing network entity;

the method further comprises deriving second key information being specific for the service providing network entity and being based on the key information being a secret of the client and the identity information related to the service providing network entity;

the method further comprises providing, from the client to the service providing network entity, the second key information as a shared secret between the client and the service providing entity;

the method further comprises providing, from the client to the service providing network entity, a proof of knowledge of the second key information;

the method further comprises providing, from the client to the service providing network entity, a digest authentication of the client by the service providing network entity;

the method further comprises generating the key information being a secret of the client by a cryptographic function of a biometric characteristic of a user of the client;

the cryptographic function is a cryptographic hash function;

the deriving, the providing and the generating are performed by a trusted platform in the client;

the method further comprises, prior to the providing, generating, at the trusted platform module, attestation key information related to the trusted platform module, requesting, at a privacy certificate authority, credential information in response to the attestation key information, and receiving, at the trusted platform module, the requested credential information;

the generating, the requesting and the receiving are performed i) only once in order to use the same attestation key information for each service providing network entity; or ii) together with the selecting, the generating, deriving and the registering in order to store and bind the attestation key information to the identity information related to the service providing network entity in the trusted platform; or iii) directly prior to the providing; or iv) by a combination of ii) and iii) in order to acquire and bind the attestation key information directly prior to an arousing need for the attestation key information;

the providing further provides, from the client to the service providing network entity, at least one a proof of knowledge of the second key information, the credential information and a proof of knowledge of the credential information;

at least one of the authenticating, the deriving, the providing, the generating, the requesting and the receiving is performed each time the client is authenticated by a service providing entity.

According to an example of the present invention, in a second aspect, this object is for example achieved by a method comprising:

determining, at a service providing network entity, first client-related identity information based on second client-related identity information being received from an identity providing entity, being different from the first client-related identity information and being based on the first client-related identity information, key information being a secret of a client and identity information related to the service providing network entity.

According to further refinements of the example of the present invention as defined under the above second aspect,

the determining is performed once per existing first client-related identity information and once per loss of the client;

the method further comprises receiving, from the client at the service providing network entity, a shared secret between the client and the service providing entity;

the method further comprises receiving, from the client at the service providing network entity, a proof of knowledge of second key information being specific for the service providing network entity and being based on the key information being a secret of the client and the identity information related to the service providing network entity;

the method further comprises receiving, from the client at the service providing network entity, a digest authentication of the client by the service providing network entity;

the method further comprises receiving, from the client at the service providing entity, second key information being specific for the service providing network entity and being based on the key information being a secret of the client and the identity information related to the service providing network entity;

the method further comprises receiving, from an identity providing network entity, the second client-related identity information;

the method further comprises determining one of a shared secret, a proof of knowledge and a digest authentication based on the second client-related identity information, and verifying one of the received shared secret, the received proof of knowledge and the received digest authentication against the corresponding one of the determined shared secret, the determined proof of knowledge and the determined digest authentication based on the second client-related identity information;

the method further comprises determining a shared secret based on the second client-related identity information, checking received credential information, and verifying a received proof of knowledge of credential information against the credential information, and a received proof of knowledge of the shared secret against the determined shared secret;

the method further comprises decrypting the second client-related identity information with the second key information in order to obtain the first client-related identity information;

the method further comprises providing, from the service providing network entity, a requested customized service to the client based on a result of verifying;

the method further comprises providing, from the service providing network entity, a requested customized service to the client based on the first client-related identity information;

at least one of the receiving, the determining, the verifying, the decrypting and the providing is performed each time the client is authenticated by a service providing entity.

According to an example of the present invention, in a third aspect, this object is for example achieved by a method comprising:

authenticating, towards a service providing network entity, second client-related identity information being received from a client, being different from first client-related identity information and being based on the first client-related identity information, key information being a secret of a client and identity information related to the service providing network entity.

According to further refinements of the example of the present invention as defined under the above first to third aspects,

the first client-related identity information is constituted by a user account at the service providing network entity;

the deriving is based on a cryptographic function;

the cryptographic function comprises at least one of deriving, public and/or private key functions, hash functions, one-way functions and symmetric encryption schemes;

the encrypting and decrypting is based on a symmetric encryption and decryption key;

the identity information related to the service providing network entity is constituted by a home uniform resource locator;

the credential information contains an attestation key identifier public key and additional information relating to trusted platform module hardware;

the additional information comprises at least one of a platform or trusted platform module manufacturer name, a platform or trusted platform module model number and a platform or trusted platform module version;

the credential information contains a pointer configured to point the service providing network entity to conformance documentation of the trusted platform in order to check whether the platform matches set requirements;

the biometric characteristic comprises at least one of a physiological characteristic and a behavioral characteristic;

the physiological characteristic comprises at least one of a face, a hand, a fingerprint and an iris of the user;

the behavioral characteristic comprises at least one of a signature and a voice of the user;

if the biometric characteristic is the fingerprint, the deriving is based on a cryptographic function meeting the following criteria: i) if two different fingers are used, the key information generated from the extracted features are different with a first probability, and ii) if the same finger is used, two key information values generated from two different finger scans are identical with a second probability;

the first probability is 0.999999;

the second probability is 0.99.

According to an example of the present invention, in a fourth aspect, this object is for example achieved by an apparatus comprising:

means for registering, from a client at a service providing network entity, first client-related identity information and, from the client at an identity providing network entity, second client-related identity information being different from the first client-related identity information and being generated based on the first client-related identity information, key information being a secret of the client and identity information related to the service providing network entity.

According to further refinements of the example of the present invention as defined under the above fourth aspect,

the apparatus further comprises means for deriving one of a shared secret between the client and the service providing entity and a proof of knowledge of the shared secret, and wherein the means for registering is further configured to register, from the client to service providing network entity, the one of the shared secret between the client and the service providing entity and the proof of knowledge of the shared secret;

the apparatus further comprises means for deriving first key information being specific for the service providing network entity and being based on the key information being a secret of the client and the identity information related to the service providing network entity;

the apparatus further comprises means for generating the second client-related identity information;

the means for generating further comprises means for deriving the second client-related identity information based on the first client-related identity information, key information being a secret of the client and identity information related to the service providing network entity;

the means for deriving is based on one of an encryption function and a cryptographic hash function;

the means for generating further comprises means for encrypting the first client-related identity information with the derived first key information in order to obtain the second client-related identity information;

the apparatus further comprises means for selecting the first client-related identity information;

the apparatus further comprises means for holding, in the client, the key information being a secret of the client;

the apparatus further comprises means for depositing the key information being a secret of the client in a trusted network entity;

the apparatus further comprises means for generating the key information being a secret of the client by a cryptographic function of a biometric characteristic of a user of the client;

the cryptographic function is a cryptographic hash function;

at least one of the means for registering, the means for deriving, the means for encrypting, the means for selecting, the means for holding, the means for depositing and the means for generating is configured to perform once per existing first client-related identity information and once per loss of the client;

the apparatus further comprises means for authenticating the client at the identity providing network entity;

the apparatus further comprises means for deriving second key information being specific for the service providing network entity and being based on the key information being a secret of the client and the identity information related to the service providing network entity;

the apparatus further comprises means for providing, from the client to the service providing network entity, the second key information as a shared secret between the client and the service providing entity;

the apparatus further comprises means for providing, from the client to the service providing network entity, a proof of knowledge of the second key information;

the apparatus further comprises means for providing, from the client to the service providing network entity, a digest authentication of the client by the service providing network entity;

the apparatus further comprises means for generating the key information being a secret of the client by a cryptographic function of a biometric characteristic of a user of the client;

the cryptographic function is a cryptographic hash function;

the means for deriving, the means for providing and the means for generating are configured to perform by a trusted platform in the client;

the apparatus further comprises means for generating, prior to the providing, at the trusted platform module, attestation key information related to the trusted platform module, means for requesting, prior to the providing, at a privacy certificate authority, credential information in response to the attestation key information, and means for receiving, prior to the providing, at the trusted platform module, the requested credential information;

the means for generating, the means for requesting and the means for receiving are configured to perform i) only once in order to use the same attestation key information for each service providing network entity; or ii) together with the means for selecting, the means for generating, means for deriving and the means for registering in order to store and bind the attestation key information to the identity information related to the service providing network entity in the trusted platform; or iii) directly prior to the means for providing; or iv) by a combination of ii) and iii) in order to acquire and bind the attestation key information directly prior to an arousing need for the attestation key information;

the means for providing is further configured to provide, from the client to the service providing network entity, at least one a proof of knowledge of the second key information, the credential information and a proof of knowledge of the credential information;

at least one of the means for authenticating, the means for deriving, the means for providing, the means for generating, the means for requesting and the means for receiving is configured to perform each time the client is authenticated by a service providing entity.

According to an example of the present invention, in a fifth aspect, this object is for example achieved by an apparatus comprising:

means for determining, at a service providing network entity, first client-related identity information based on second client-related identity information being received from an identity providing entity, being different from the first client-related identity information and being based on the first client-related identity information, key information being a secret of a client and identity information related to the service providing network entity.

According to further refinements of the example of the present invention as defined under the above fifth aspect,

the means for determining is configured to perform once per existing first client-related identity information and once per loss of the client;

the apparatus further comprises means for receiving, from the client at the service providing network entity, a shared secret between the client and the service providing entity;

the apparatus further comprises means for receiving, from the client at the service providing network entity, a proof of knowledge of second key information being specific for the service providing network entity and being based on the key information being a secret of the client and the identity information related to the service providing network entity;

the apparatus further comprises means for receiving, from the client at the service providing network entity, a digest authentication of the client by the service providing network entity;

the apparatus further comprises means for receiving, from the client at the service providing entity, second key information being specific for the service providing network entity and being based on the key information being a secret of the client and the identity information related to the service providing network entity;

the apparatus further comprises means for receiving, from an identity providing network entity, the second client-related identity information;

the apparatus further comprises means for determining one of a shared secret, a proof of knowledge and a digest authentication based on the second client-related identity information, and means for verifying one of the received shared secret, the received proof of knowledge and the received digest authentication against the corresponding one of the determined shared secret, the determined proof of knowledge and the determined digest authentication based on the second client-related identity information;

the apparatus further comprises means for determining a shared secret based on the second client-related identity information, checking received credential information, and means for verifying a received proof of knowledge of credential information against the credential information, and a received proof of knowledge of the shared secret against the determined shared secret;

the apparatus further comprises means for decrypting the second client-related identity information with the second key information in order to obtain the first client-related identity information;

the apparatus further comprises means for providing, from the service providing network entity, a requested customized service to the client based on a result of verifying;

the apparatus further comprises means for providing, from the service providing network entity, a requested customized service to the client based on the first client-related identity information;

at least one of the means for receiving, the means for determining, the means for verifying, the means for decrypting and the means for providing is configured to perform each time the client is authenticated by a service providing entity.

According to an example of the present invention, in a sixth aspect, this object is for example achieved by an apparatus comprising:

means for authenticating, towards a service providing network entity, second client-related identity information being received from a client, being different from first client-related identity information and being based on the first client-related identity information, key information being a secret of a client and identity information related to the service providing network entity.

According to further refinements of the example of the present invention as defined under the above fourth to sixth aspects,

the first client-related identity information is constituted by a user account at the service providing network entity;

the deriving is based on a cryptographic function;

the cryptographic function comprises at least one of deriving, public and/or private key functions, hash functions, one-way functions and symmetric encryption schemes;

the means for encrypting and means for decrypting is based on a symmetric encryption and decryption key;

the identity information related to the service providing network entity is constituted by a home uniform resource locator;

the credential information contains an attestation key identifier public key and additional information relating to trusted platform module hardware;

the additional information comprises at least one of a platform or trusted platform module manufacturer name, a platform or trusted platform module model number and a platform or trusted platform module version;

the credential information contains a pointer configured to point the service providing network entity to conformance documentation of the trusted platform in order to check whether the platform matches set requirements;

the biometric characteristic comprises at least one of a physiological characteristic and a behavioral characteristic;

the physiological characteristic comprises at least one of a face, a hand, a fingerprint and an iris of the user;

the behavioral characteristic comprises at least one of a signature and a voice of the user;

if the biometric characteristic is the fingerprint, the means for deriving is based on a cryptographic function meeting the following criteria: i) if two different fingers are used, the key information generated from the extracted features are different with a first probability, and ii) if the same finger is used, two key information values generated from two different finger scans are identical with a second probability;

the first probability is 0.999999;

the second probability is 0.99;

the trusted platform comprises at least one of a trusted platform module, a finger print reader module, and a module for executing cryptographic functions required for the means for deriving;

the modules are assembled tamper-proof;

the tamper-proof assembled modules form a boundary;

the finger print reading module and a subscriber identity module card reading module are comprised in a universal serial bus stick;

at least one, or more of means for registering, means for deriving, means for encrypting, means for selecting, means for holding, means for depositing, means for generating, means for authenticating, means for providing, means for requesting, means for receiving, means for determining, means for verifying, means for decrypting and the apparatus is implemented as a chipset or module.

According to an example of the present invention, in a seventh aspect, this object is for example achieved by a system comprising:

an apparatus according to the above fourth aspect;

an apparatus according to the above fifth aspect; and

an apparatus according to the above sixth aspect.

According to an example of the present invention, in an eighth aspect, this object is for example achieved by a computer program product comprising code means for performing a method according to any one of the above first to third aspects when run on a processing means or module.

In this connection, examples of the present invention enable one or more of the following:

Preventing that the IdP is able to impersonate the client and to carry out any action that the client is entitled to do at the service providers;

Eliminating security threats, thus enhancing the client's privacy;

Independence, for the client, from non-maliciousness and secure infrastructure of the IdP, such as untrustworthy insiders in the IdP and unwanted subcontractors of the IdP;

Eliminating the possibility for the IdP to impersonate the client;

Preventing exposure of identity-related information of the client to the IdP;

Eliminating security threats in existing architectures: GBA (see FIG. 1B) and Radius Authentication are based on shared-secret authentication (the client and the IdP possessing the same key) or other shared-secret based mechanism. In case of Liberty/SAML (see FIG. 1C), OpenID (see FIG. 1D) and Windows Cardspace™ (see FIG. 1E), the SP only verifies the authentication assertion received from the IdP (i.e. the IdP is able to assert any client identity intended). The situation is similar in CAS (see FIG. 1F), where the ticket is first presented by the client to the SP and then SP validates it with the CAS;

Incorporating, into a security scheme, a secret such that the secret is only available to the client;

Enabling recovering from a situation where the client has lost the secret (e.g. has lost the device that stores the secret or the device is stolen);

Allowing implementation in existing infrastructure with only minor modifications, e.g. extensions;

Dispensing with a need for a separate security protocol.

### BRIEF DESCRIPTION OF THE DRAWINGS

Examples of the present invention are described herein below with reference to the accompanying drawings, in which:

FIG. 1A shows the above-described principle underlying single sign-on;

FIGS. 1B to 1G show implementation examples of the above-described principle in different existing architectures;

FIG. 2 shows the principle underlying a first example of the present invention;

FIGS. 3A and 3B show methods for privacy-enhanced identity management according to the first example of the present invention;

FIGS. 4A and 4B show apparatuses for privacy-enhanced identity management according to the first example of the present invention;

FIG. 5 shows the principle underlying a second example of the present invention;

FIGS. 6A and 6B show methods for privacy-enhanced identity management according to the second example of the present invention;

FIGS. 7A and 8B show apparatuses for privacy-enhanced identity management according to the second example of the present invention;

FIG. 8 shows the principle underlying a third example of the present invention;

FIGS. 9A and 9B show methods for privacy-enhanced identity management according to the third example of the present invention;

FIGS. 10A and 10B show apparatuses for privacy-enhanced identity management according to the third example of the present invention;

FIG. 11 shows the principle underlying a fourth example of the present invention;

FIGS. 12A and 12B show methods for privacy-enhanced identity management according to the fourth example of the present invention; and

FIGS. 13A and 13B show apparatuses for privacy-enhanced identity management according to the fourth example of the present invention.

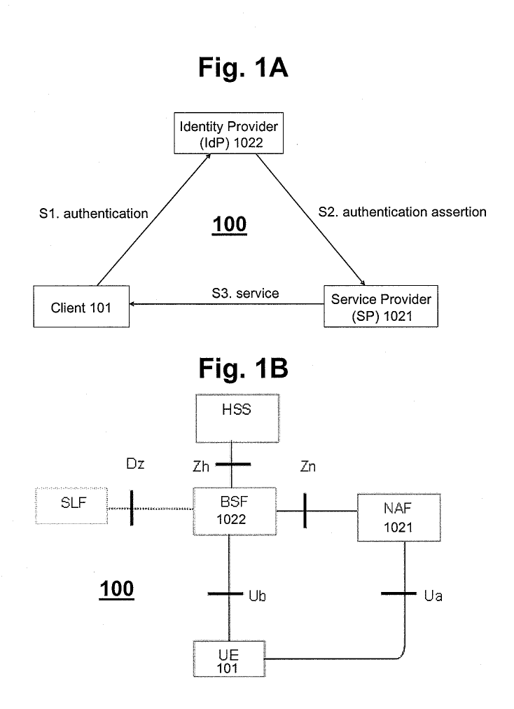

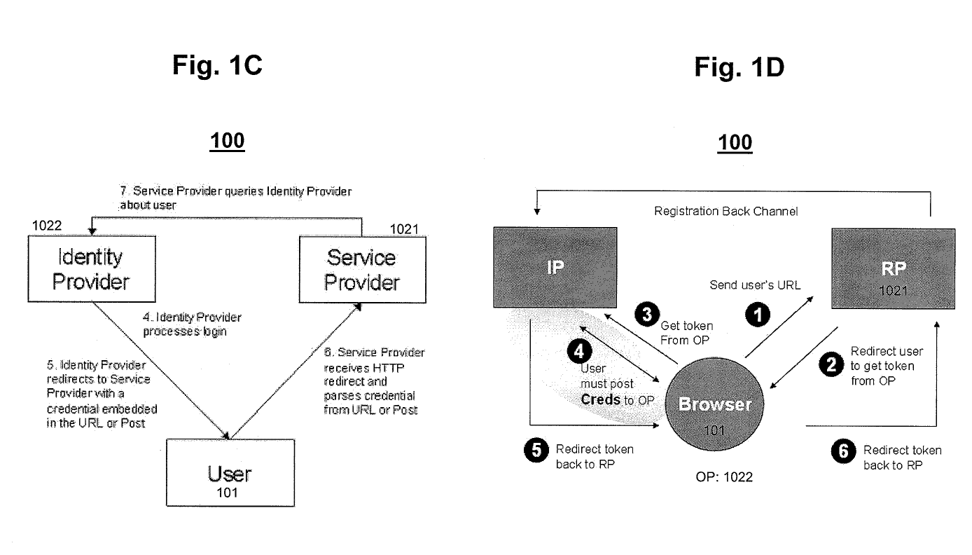

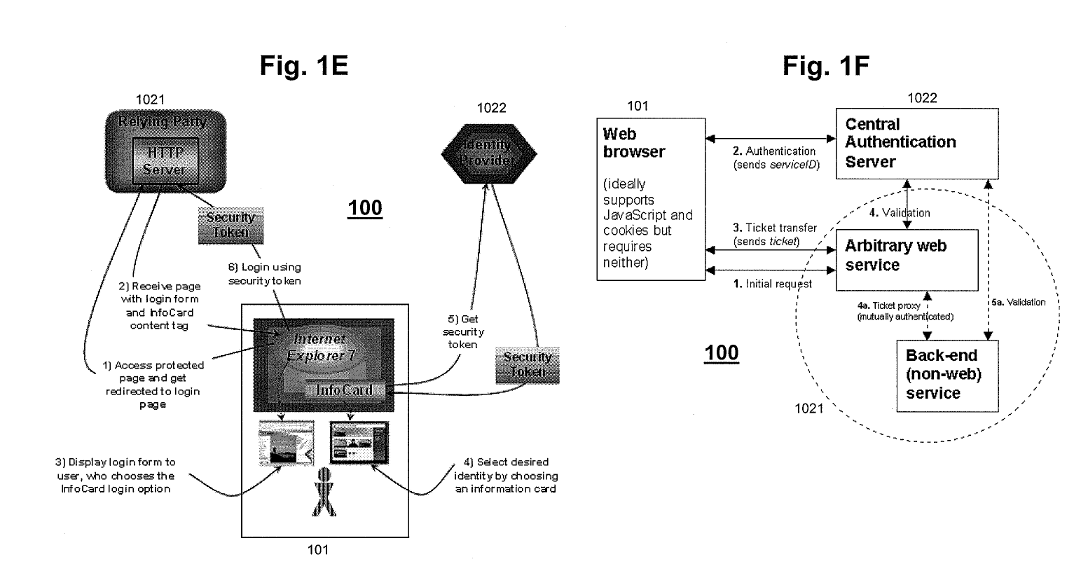

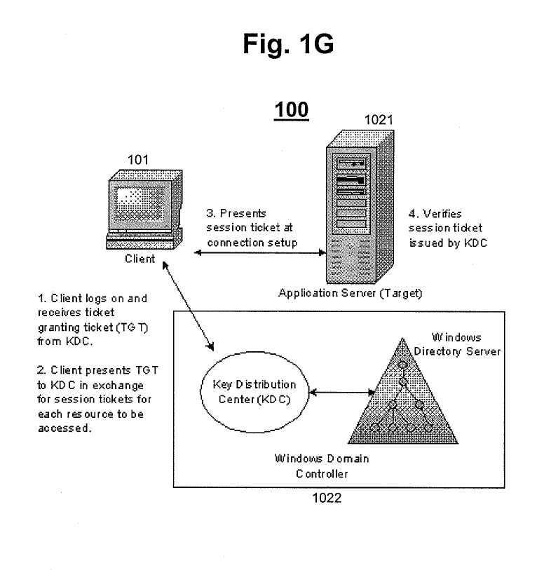

### DETAILED DESCRIPTION OF EXAMPLES OF THE PRESENT INVENTION

Examples of the present invention are described herein below by way of example with reference to the accompanying drawings.

It is to be noted that for this description, the terms “user account at the service providing network entity; cryptographic function; symmetric encryption and decryption key; home uniform resource locator; attestation key identifier; and physiological characteristic (face, hand, fingerprint and/or iris of the user) and a behavioral characteristic (signature and/or voice of the user)” are examples for “first client-related identity information; deriving, public and/or private key functions, hash functions, one-way functions and symmetric encryption schemes; encrypting and decrypting; identity information related to the service providing network entity; credential information; and biometric characteristic”, respectively, without restricting the latter-named terms to the special technical or implementation details imposed to the first-named terms.

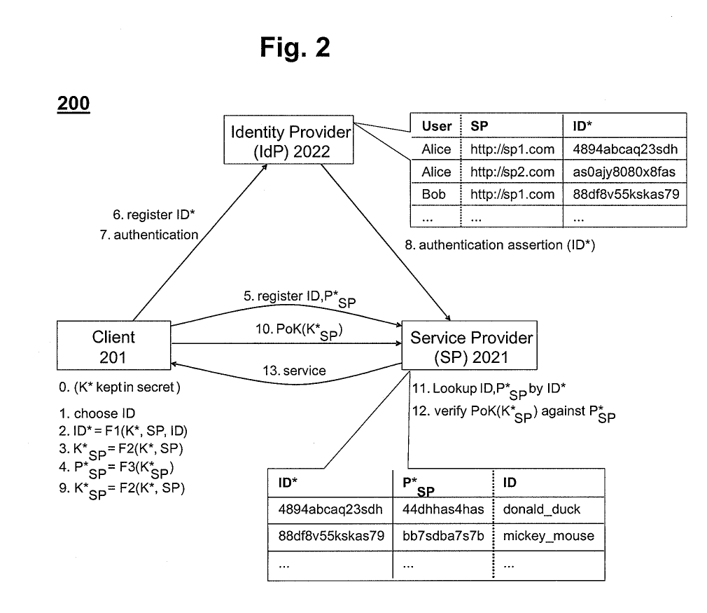

FIG. 2 shows the principle of the first example of the present invention, to which principle the present invention is not to be restricted to. As shown in FIG. 2, a communication network 200 may comprise a client 201 and a core network 202 (not shown). The core network 202 may in turn comprise an SP 2021 and an IdP 2022. It is to be noted that any reference to steps S1 to S12 refers to “1.” to “12.” in FIG. 2. Furthermore, the term “core network” may also refer to other networks than that of the service provider and/or the identity provider.

In step S0, it is assumed that the client 201 has already generated a secret key K* which is never disclosed (e.g. kept in secret on the client 201).

Steps S1 to S6 may be performed by the client 201 once per user account (e.g. ID) in the SP 2021 and additionally once per device loss (i.e. in case the secret key K* gets lost). In step S1, the client 201 may first choose e.g. the SP-specific ID such as the user account at the SP 2021. Then, in step S2, the client 201 may derive an opaque identifier ID* from K*, ID and the identifier (e.g. home URL) of the SP 2021 e.g. by the cryptographic function F1. In step S3, the client 201 may also derive an SP-specific secret K*_{SP} from K* and the identifier of the SP e.g. by the cryptographic function F2, and, in step S4, may derive a corresponding P*_{SP} value by the function F3. In a first case, P*_{SP}=K*_{SP}, i.e. K*_{SP} may be a shared secret between the client 201 and the SP 2021; in a second case, F3(·) may be a cryptographic function and K*_{SP} may never be disclosed, i.e. only a proof of knowledge of K*_{SP} is performed.

Then, in step S5, the client 201 may register the pair ID and e.g. P*_{SP} at the SP 2021, and, in step S6, may also register ID* at the IdP 2022 as the SP-specific identifier.

Steps S7 to S13 may be performed each time the client 201 is authenticated by the SP 2021. In step S7, the client may authenticate itself at the IdP 2022. Subsequently, in step S8, the SP 2021 may receive an authentication assertion, containing the identifier ID*, from the IdP 2022. Nearly at the same time, in step S9, the client 201 may generate the SP-specific secret K*_{SP} again, and in step S10, may provide the SP 2021 with a proof of knowledge of K*_{SP} denoted by PoK(K*_{SP}). It is to be noted that the term “nearly at the same time” depends on the actual implementation or protocol specification. The two steps—the authentication assertion run involving the SP 2021, IdP 2022 and the client 201, and the proof-of-knowledge run between the client 201 and the SP 2021—may happen in any order or even interleaved.

In step S11, using ID* as a primary key, the SP 2021 may look up the (real user account) ID and the value P*_{SP}, and, in step S12, may verify the proof of knowledge against the value P*_{SP}. In step S13, if the verification succeeds, the SP 2021 may eventually provide the requested personalized service to the client 201.

It is further to be noted that e.g. in case of device loss, i.e. when the client 201 has lost the secret key K*, the authentication flow may break (i.e. the client 201 may not be able to generate K*_{SP} for step S10). In order to recover from this situation, the client 201 may first have to generate a new master secret K*, and then steps S2 to S6 may be repeated for each ID of the client 201 at each SP 2021. However, in order to prevent the IdP 2021 from generating an own master key K*—hence impersonating the client—, step S5 may be performed e.g. with additional direct authentication of the client 201 by the SP 2021, e.g. by sending a confirmation link to the (earlier registered) private e-mail address of the client 201.

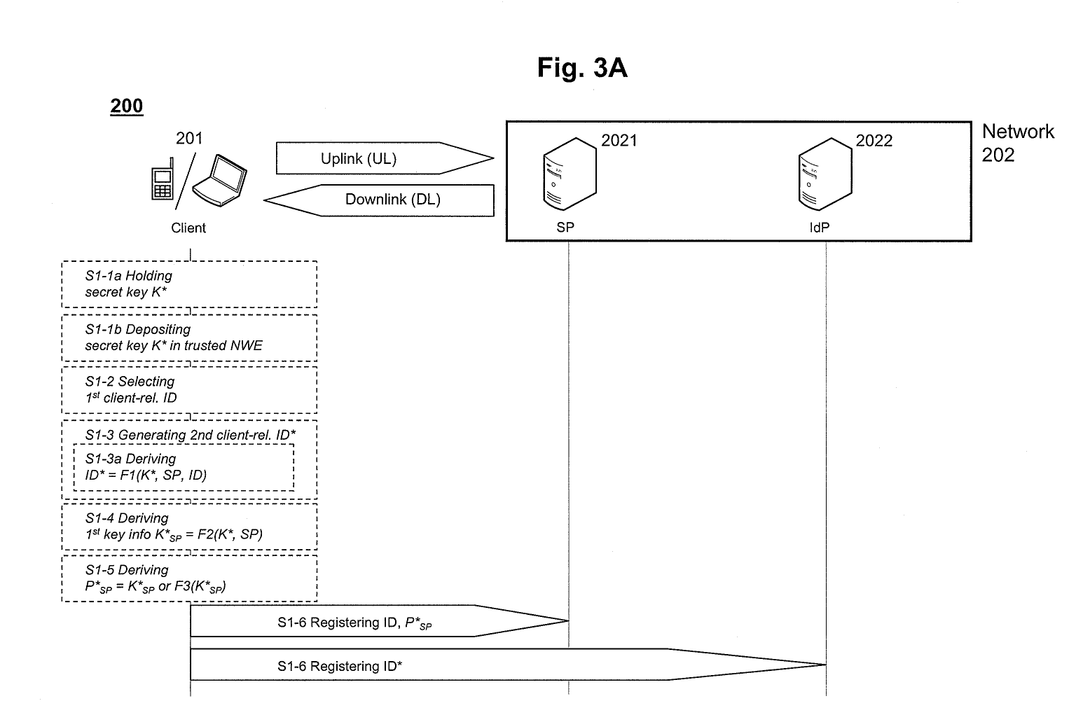

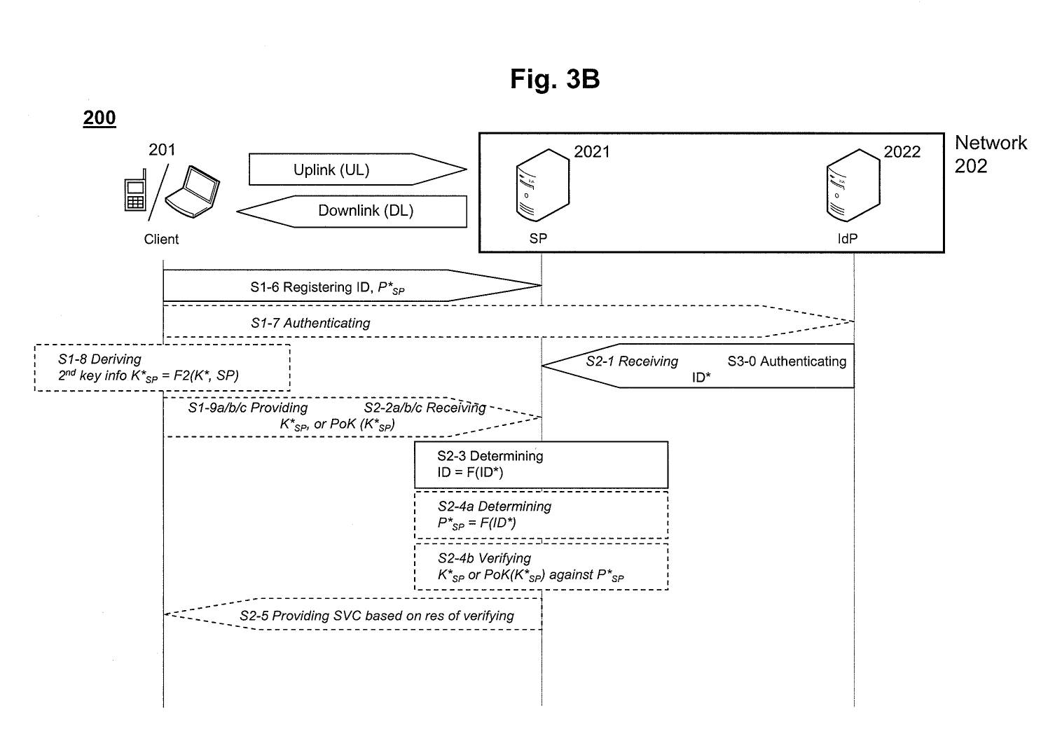

FIGS. 3A and 3B show methods for privacy-enhanced identity management according to the first example of the present invention. Signaling between elements is indicated in horizontal direction, while time aspects between signaling may be reflected in the vertical arrangement of the signaling sequence as well as in the sequence numbers. It is to be noted that the time aspects indicated in FIGS. 3A and 3D do not necessarily restrict any one of the method steps shown to the step sequence outlined. This applies in particular to method steps that are functionally disjunctive with each other: as described above, this applies e.g. to steps S1-6 (registering), S1-7 (authenticating) and S1-9 (providing). Within FIGS. 3A and 3B, for ease of description, means or portions which may provide main functionalities are depicted with solid functional blocks or arrows and/or a normal font, while means or portions which may provide optional functions are depicted with dashed functional blocks or arrows and/or an italic font.

As for FIGS. 3A and 3B, means and portions identical to those in FIG. 2 are denoted by the same reference signs, and description thereof is omitted for the sake of brevity.

First, in an optional step S1-1a, e.g. the client 201 may perform holding, in the client, key information being a secret of the client. Further, in an optional step S1-1b, e.g. the client 201 may perform depositing the key information being a secret of the client in a further trusted network entity (not shown).

In an optional step S1-2, e.g. the client 201 may perform selecting first client-related identity information (e.g. ID, such as user account).

Then, in an optional step S1-3, e.g. the client 201 may perform generating second client-related identity information (e.g. ID*) being different from the first client-related identity information based on the first client-related identity information, the key information (K*) being a secret of the client and identity information (e.g. SP) related to the service providing network entity 2021. Further, in the first example of the present invention, e.g. the client 201 may perform, in an optional step S1-3a, as a part of the generating, deriving the second client-related identity information (e.g. ID*) based on the first client-related identity information, the key information (e.g. K*) being a secret of the client 201 and the identity information (e.g. SP) related to the service providing network entity. The deriving may be based on an encryption function or a cryptographic hash function.

Then, in an optional step S1-4, e.g. the client 201 may perform deriving first key information (e.g. K*_{SP}) being specific for the service providing network entity 2021 and being based on the key information being a secret of the client 201 and the identity information (e.g. SP) related to the service providing network entity 2021.

In a further optional step S1-5, e.g. the client 201 may perform deriving a shared secret (e.g. P*_{SP}=K*_{SP}) between the client 201 and the service providing entity 2021 or a proof of knowledge (e.g. P*_{SP}=F3(K*_{SP})) of the shared secret. In this case, the registering, from the client 201 to service providing network entity 2021, may further comprise the shared secret between the client 201 and the service providing entity 2021 and the proof of knowledge (Pok) of the shared secret.

Then, in step S1-6, e.g. the client 201 may perform registering, from the client 201 at the service providing network entity 2021, the first client-related identity information (e.g. ID) and, from the client 201 at the identity providing network entity 2022, the second client-related identity information (e.g. ID*).

Furthermore, the registering, the deriving, the selecting, the holding, the depositing and/or the generating may be performed once per existing first client-related identity information and once per loss of the client.

Then, in an optional step S1-7, e.g. the client 201 may perform authenticating the client 201 at the identity providing network entity 2022.

In an optional step S1-8, e.g. the client 201 may perform deriving second key information (e.g. K*_{SP}) being specific for the service providing network entity 2021 and being based on the key information (e.g. K*) being a secret of the client 201 and the identity information (e.g. SP) related to the service providing network entity 2021.

Then, in an optional step S1-9a, e.g. the client 201 may perform providing, from the client 201 to the service providing network entity 2021, the second key information as a shared secret (P*_{SP}=K*_{SP}) between the client 201 and the service providing entity 2021. Alternatively, in an optional step S1-9b, e.g. the client 201 may perform providing, from the client 201 to the service providing network entity 2021, a proof of knowledge of the second key information. Alternatively, in an optional step S1-9c, e.g. the client 201 may perform providing, from the client 201 to the service providing network entity 2021, a digest authentication of the client 201 by the service providing network entity 2021.

Furthermore, the authenticating, the deriving, and/or the providing may be performed each time the client is authenticated by a service providing entity.

Further, e.g. after the authenticating in optional step S1-7, in step S3-0, e.g. the IdP 2022 may perform authenticating, towards the service providing network entity 2021, the second client-related identity information (ID*) being received from the client 201 (e.g. in step S1-6). In response, in an optional step S2-1, e.g. the SP 2021 may perform receiving, from the identity providing network entity 2022, the second client-related identity information.

Then, in one of optional steps S2-2a to S2-2c, e.g. the SP 2021 may perform receiving, from the client 201 at the service providing entity 2021, a shared secret (P*_{SP}=K*_{SP}) between the client 201 and the service providing entity 2021, a proof of knowledge of the second key information or the digest authentication of the client 201 by the service providing network entity 2021.

Then, in step S2-3, e.g. the SP 2021 may perform determining the first client-related identity information (e.g. ID) based on the second client-related identity information (ID*) being received from the identity providing entity 2022. The determining may be performed once per existing first client-related identity information and once per loss of the client.

Then, in an optional step S2-4a, e.g. the SP 2021 may perform determining a shared secret (e.g. P*_{SP}), a proof of knowledge or a digest authentication based on the second client-related identity information (e.g. ID*). And, in optional step S2-4b, e.g. the SP 2021 may perform verifying the received shared secret, the received proof of knowledge or the received digest authentication against the corresponding determined shared secret (e.g. P*_{SP}), the determined proof of knowledge or the determined digest authentication based on the second client-related identity information (e.g. ID*).

Finally, in an optional step S2-5, e.g. the SP 2021 may perform providing a requested customized service to the client 201 based on a result of verifying.

As for developments of the methods of the first example of the present invention, the first client-related identity information may be constituted by a user account at the service providing network entity. Furthermore, the deriving may be based on a cryptographic function, and the encrypting and decrypting may be based on a symmetric encryption and decryption key. Further, the identity information related to the service providing network entity may be constituted by a home uniform resource locator.

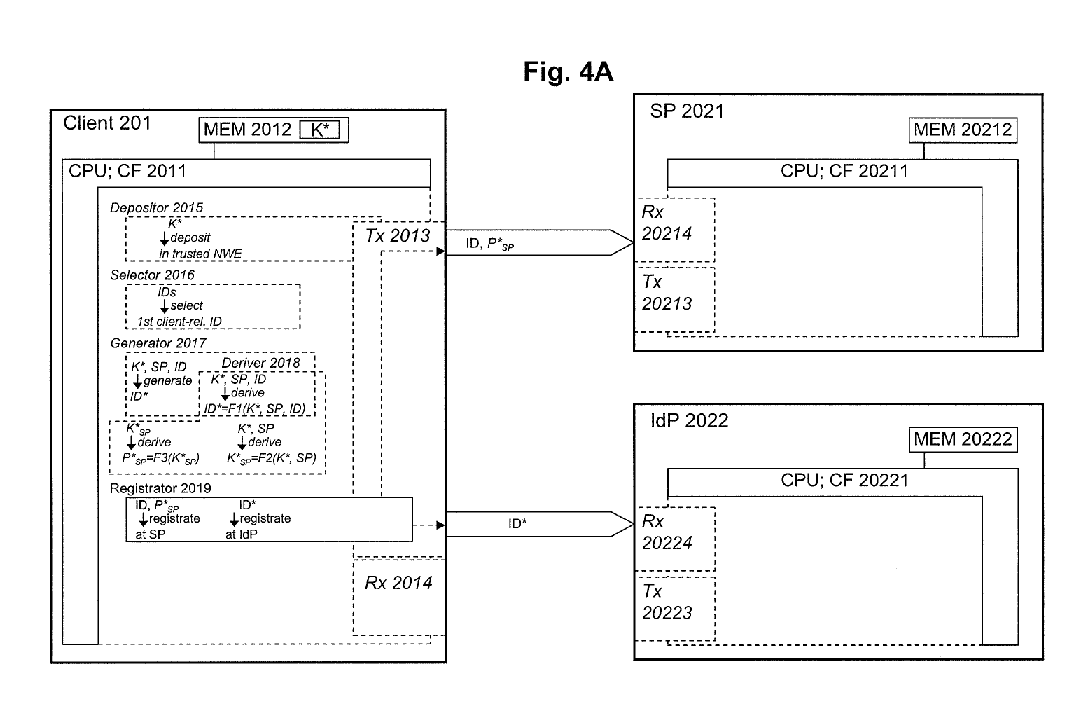

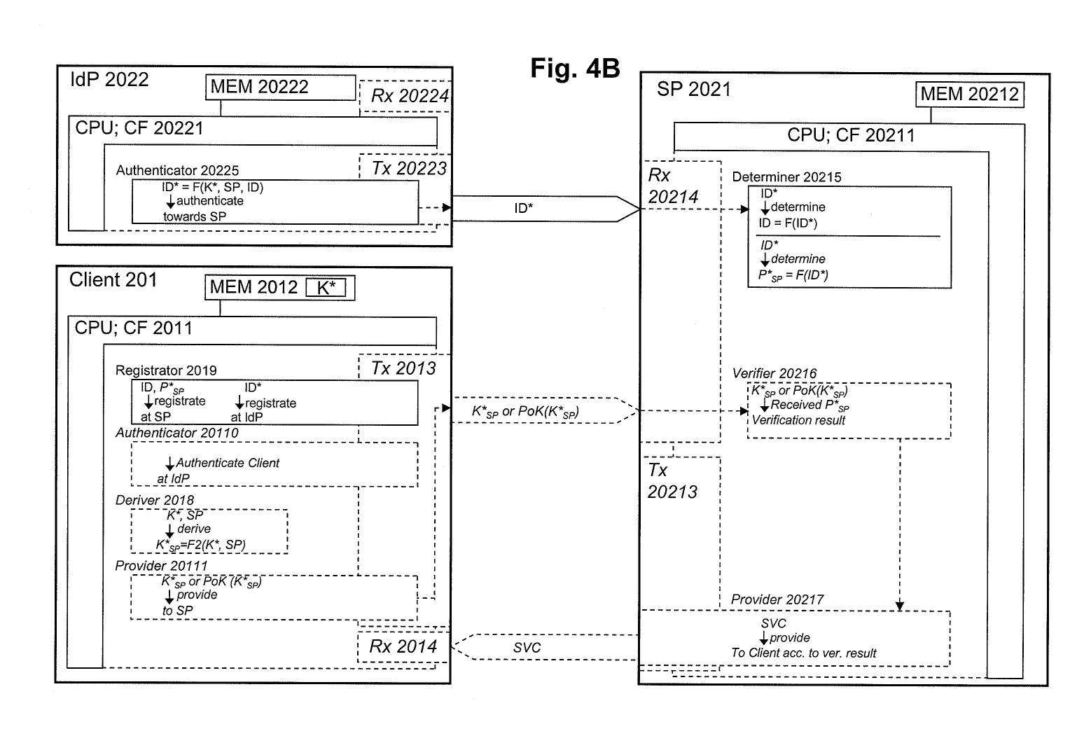

FIGS. 4A and 4B show apparatuses (e.g. client 201, SP 2021 and IdP 2022) for network communication parameter configuration according to the first example of the present invention. Within FIGS. 4A and 4B, for ease of description, means or portions which may provide main functionalities are depicted with solid functional blocks or arrows and a normal font, while means or portions which may provide optional functions are depicted with dashed functional blocks or arrows and an italic font.

The client 201 may comprise a CPU (or core functionality CF) 2011, a memory (or means for holding) 2012, an optional transmitter (or means for transmitting) 2013, an optional receiver (or means for receiving) 2014, an optional depositor (or means for depositing) 2015, an optional selector (or means for selecting) 2016, an optional generator (or means for generating) 2017, an optional deriver (or means for deriving) 2018, a registrator (or means for registrating) 2019, an optional authenticator (or means for authenticating) 20110 and an optional provider (or means for providing) 20111 and an optional secure element (not shown) to provide secure storage and optionally an execution environment for sensitive operations, e.g. cryptographic functions (e.g. implemented using an M-shield chip or a smart card), and optionally a secure key derivation environment.

Further, the SP 2021 may comprise a CPU (or core functionality CF) 20211, a memory 20212, an optional transmitter (or means for transmitting) 20213, an optional receiver (or means for receiving) 20214, a determiner (or means for determining) 20215, an optional verifier (or means for verifying) 20216 and an optional provider (or means for providing) 20217.

Finally, the IdP 2022 may comprise a CPU (or core functionality CF) 20221, a memory 20222, an optional transmitter (or means for transmitting) 20223, an optional receiver (or means for receiving) 20224 and an authenticator (or means for authenticating) 20225.

As indicated by the dashed extensions of the functional blocks of the CPUs 2011, 20211, 20221, the means for depositing 2015, the means for selecting 2016, the means for generating 2017, the means for deriving 2018, the means for registrating 2019, the means for authenticating 20110 and the means for providing 20111 of the client 201, the means for determining 20215, the means for verifying 20216 and the means for providing 20217 of the SP 2021 as well as the means for authenticating 20225 of the IdP 2022 may be functionalities running on the CPUs 2011, 20211, 20221 of the client 201, the SP 2021 or the IdP 2022, respectively, or may alternatively be separate functional entities or means. Furthermore, means overlapping one another may also be configured to utilize one another's functionalities, e.g. the means for providing 20111 of the client 201 or the means for authenticating 20225 may utilize the functionality of the respective means for transmitting 2013, 20223 etc. The same applies to means being connected with arrows, e.g. means for determining 20215 and means for receiving 20214 or means for verifying 20216 and means for receiving 20214 etc.

The CPUs 20x1 (wherein x=1, 21 and 22) may respectively be configured to process various data inputs and to control the functions of the memories 20x2, the means for transmitting 202x3 and the means for receiving 20x4 (and the means for depositing 2015, the means for selecting 2016, the means for generating 2017, the means for deriving 2018, the means for registrating 2019, the means for authenticating 20110 and the means for providing 20111 of the client 201, the means for determining 20215, the means for verifying 20216 and the means for providing 20217 of the SP 2021 as well as the means for authenticating 20225 of the IdP 2022). The memories 20x2 may serve e.g. for storing code means for carrying out e.g. the methods according to the first to fourth examples of the present invention, when run e.g. on the CPUs 20x1. It is to be noted that the means for transmitting 20x3 and the means for receiving 20x4 may alternatively be provided as respective integral transceivers. It is further to be noted that the transmitters/receivers may be implemented i) as physical transmitters/receivers for transceiving e.g. via the air interface (e.g. in case of transmitting between the client 201 and the SP 2021), ii) as routing entities e.g. for transmitting/receiving data packets e.g. in a PS (packet switched) network (e.g. between the SP 2021 and the IdP 2022 when disposed as separate network entities), iii) as functionalities for writing/reading information into/from a given memory area (e.g. in case of shared/common CPUs or memories e.g. of the SP 2021 and the IdP 2022 when disposed as an integral network entity), or iv) as any suitable combination of i) to iii).

First, e.g. the means for holding 2012 of the client 201 may perform holding key information being a secret of the client 201. Further, e.g. the means for depositing 2015 of the client 201 may perform depositing the key information being a secret of the client 201 in a further trusted network entity (not shown) or trusted hardware element (security element, not shown).

E.g. the means for selecting 2016 of the client 201 may perform selecting first client-related identity information (e.g. ID, such as user account).

Then, e.g. the means for generating 2017 of the client 201 may perform generating second client-related identity information (e.g. ID*) being different from the first client-related identity information based on the first client-related identity information, the key information (K*) being a secret of the client and identity information (SP) related to the service providing network entity 2021. Further, in the first example of the present invention, e.g. the means for deriving 2018 of the client 201 may perform, a part of the means for generating 2017, deriving the second client-related identity information (ID*) based on the first client-related identity information, the key information (K*) being a secret of the client 201 and the identity information (SP) related to the service providing network entity. The deriving performed by the means for deriving 2018 may be based on an encryption function or a cryptographic hash function.

Then, e.g. the means for deriving 2018 the client 201 may perform deriving first key information (K*_{SP}) being specific for the service providing network entity 2021 and being based on the key information being a secret of the client 201 and the identity information (SP) related to the service providing network entity 2021.

E.g. the means for deriving 2018 of the client 201 may perform deriving a shared secret (e.g. P*_{SP}=K*_{SP}) between the client 201 and the service providing entity 2021 or a proof of knowledge (e.g. P*_{SP}=F3(K*_{SP})) of the shared secret. In this case, the means for registering 2019 of the client 201 may further register the shared secret between the client 201 and the service providing entity 2021 and the proof of knowledge (Pok) of the shared secret.

Then, e.g. the means for registrating 2019 of the client 201 may perform registering, from the client 201 at the service providing network entity 2021, the first client-related identity information (e.g. ID) and, from the client 201 at the identity providing network entity 2022, the second client-related identity information (e.g. ID*).

Furthermore, the means for registering, the means for deriving, the means for selecting, the means for holding, the means for depositing and/or the means for generating may be configured to perform once per existing first client-related identity information and once per loss of the client.

Then, e.g. the means for authenticating 20110 of the client 201 may perform authenticating the client 201 at the identity providing network entity 2022.

E.g. the means for deriving 2018 of the client 201 may perform deriving second key information (e.g. K*_{SP}) being specific for the service providing network entity 2021 and being based on the key information (e.g. K*) being a secret of the client 201 and the identity information (e.g. SP) related to the service providing network entity 2021.

Then, e.g. the means for providing 20111 of the client 201 may perform providing, from the client 201 to the service providing network entity 2021, the second key information as a shared secret (P*_{SP}=K*_{SP}) between the client 201 and the service providing entity 2021. Alternatively, e.g. the means for providing 20111 of the client 201 may perform providing, from the client 201 to the service providing network entity 2021, a proof of knowledge of the second key information. Alternatively, e.g. the means for providing 20111 of the client 201 may perform providing, from the client 201 to the service providing network entity 2021, a digest authentication of the client 201 by the service providing network entity 2021.

Furthermore, the means for authenticating, the means for deriving, and/or the means for providing may be configured to perform each time the client is authenticated by a service providing entity.

Further, e.g. after the authenticating by the means for authenticating 20110, e.g. the means for authenticating 20225 of the IdP 2022 may perform authenticating, towards the service providing network entity 2021, the second client-related identity information (e.g. ID*) being received from the client 201. In response, e.g. the means for receiving 20214 of the SP 2021 may perform receiving, from the identity providing network entity 2022, the second client-related identity information.

Then, e.g. the means for receiving 20214 of the SP 2021 may perform receiving, from the client 201 at the service providing entity 2021, a shared secret (P*_{SP}=K*_{SP}) between the client 201 and the service providing entity 2021, a proof of knowledge of the second key information or the digest authentication of the client 201 by the service providing network entity 2021.

Then, e.g. the means for determining 20215 of the SP 2021 may perform determining the first client-related identity information (e.g. ID) based on the second client-related identity information (ID*) being received from the identity providing entity 2022. The determining performed by the means for determining 20215 may be performed once per existing first client-related identity information and once per loss of the client.

Then, e.g. the means for determining 20215 of the SP 2021 may perform determining a shared secret (e.g. P*_{SP}), a proof of knowledge or a digest authentication based on the second client-related identity information (e.g. ID*). And, e.g. the means for verifying 20216 of the SP 2021 may perform verifying the received shared secret, the received proof of knowledge or the received digest authentication against the corresponding determined shared secret (e.g. P*_{SP}), the determined proof of knowledge or the determined digest authentication based on the second client-related identity information (e.g. ID*).

Finally, e.g. the means for providing 20217 of the SP 2021 may perform providing a requested customized service to the client 201 based on a result of verifying.

As for developments of the apparatuses of the first example of the present invention, the first client-related identity information may be constituted by a user account at the service providing network entity. Furthermore, the deriving may be based on a cryptographic function, and the encrypting and decrypting may be based on a symmetric encryption and decryption key. Further, the identity information related to the service providing network entity may be constituted by a home uniform resource locator.

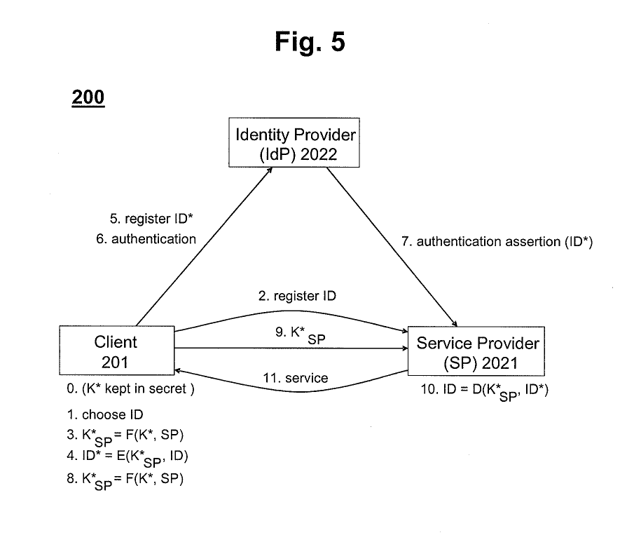

FIG. 5 shows the principle of the second example of the present invention, to which principle the present invention is not to be restricted to. Again, as shown in FIG. 5, the communication network 200 may comprise the client 201 and the core network 202 (not shown). The core network 202 may in turn comprise the SP 2021 and the IdP 2022. It is to be noted that any reference to steps S1 to S10 refers to “1.” to “10.” in FIG. 5.

Again, in step S0, it is assumed that the client 201 already possesses the master key K*.

Steps S1 to S5 may be performed by the client 201 once per SP user account and additionally once per device loss. In step S1, the client 201 may choose the SP-specific ID, e.g. the user account at the SP. In step S2, the client 201 may register at the SP 2021. Then, in step S3, the client 201 may derive an SP-specific encryption/decryption key (K*_{SP}) from the secret key K* and the identifier (e.g. home URL) of the SP 2021 e.g. by the cryptographic function F. In step S4, the client 201 may encrypt the ID e.g. by the encryption function (E) using the key K*_{SP}, obtaining ID*. Then, in step S5, the client 201 may register the encrypted ID (=ID*) at the IdP 2022 as the SP-specific identifier.

Steps S6 to S11 may be performed each time the client 201 is authenticated by the SP 2021. In step S6, the client 201 may authenticate at the IdP 2022. Subsequently, in step S7, the SP 2021 may receive an authentication assertion, containing e.g. the identifier ID*, from the IdP 2022. At roughly the same time, in step S8, the client 201 may derive the SP-specific encryption/decryption key K*_{SP} again, and, in step S9, may send the decryption key to the SP 2021. In step S10, the SP 2021 may then decrypt the ID* by the decryption function D using the key K*_{SP}, obtaining the ID. In step S11, the SP 2021 may then provide the requested service.

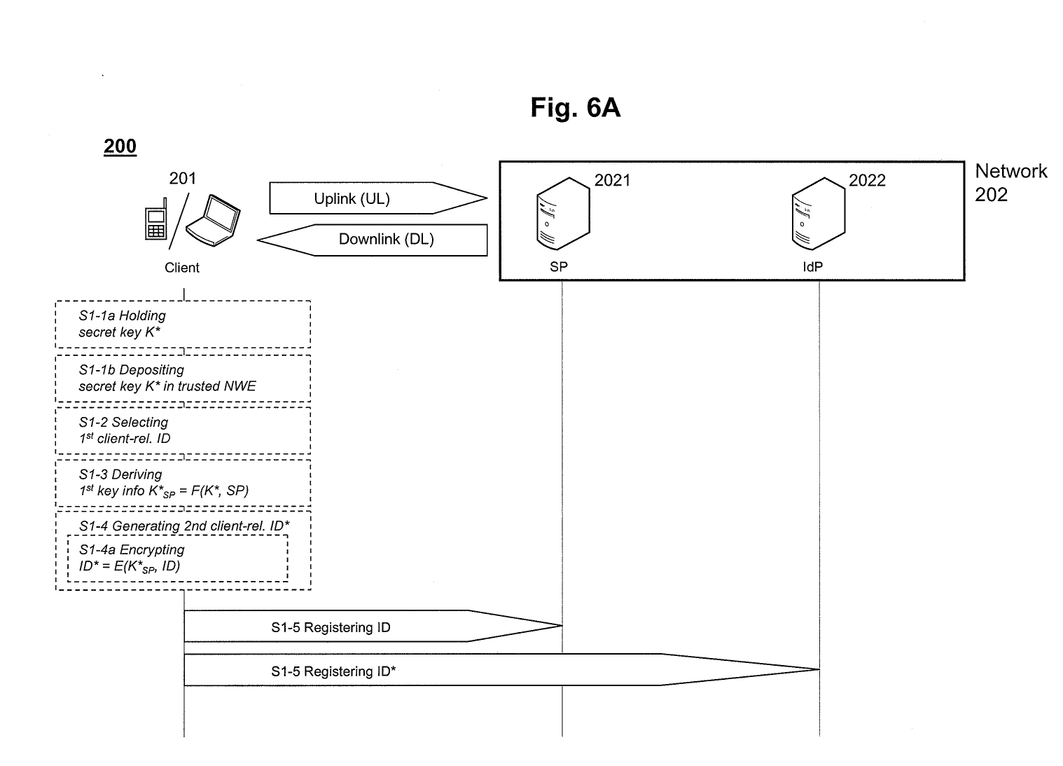

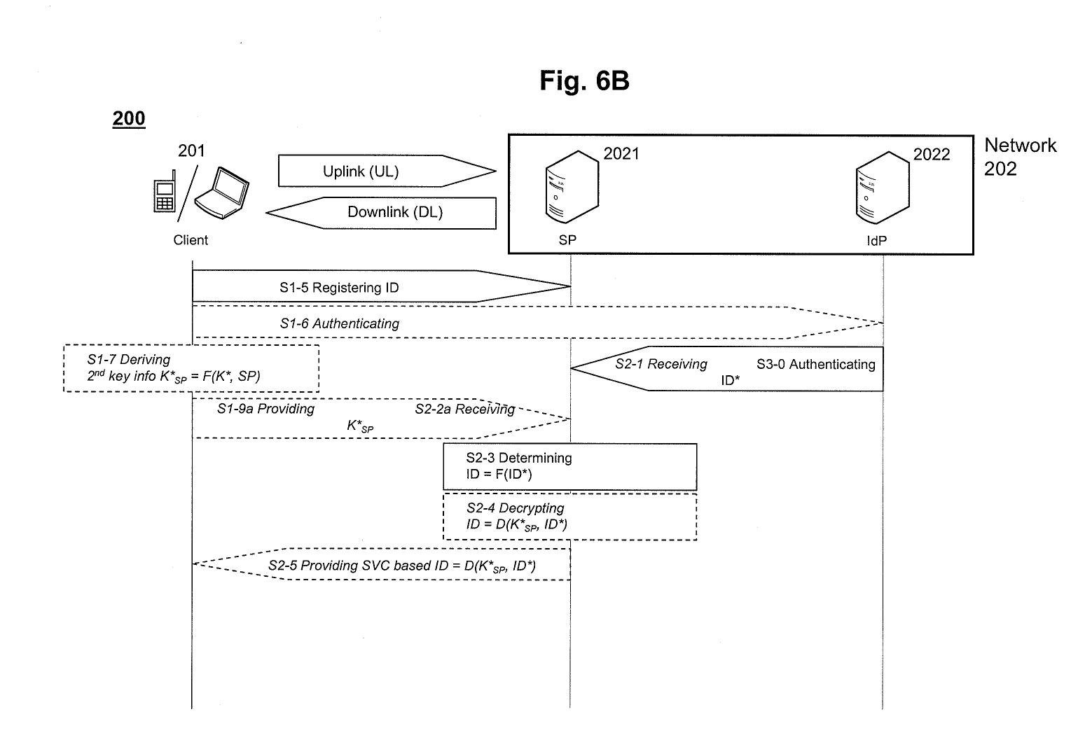

FIGS. 6A and 6B show methods for privacy-enhanced identity management according to the second example of the present invention. Reference signs identical to those in FIGS. 3A and 3B designate the same or similar means or portions. Likewise, description of steps identical to those shown in FIGS. 3A and 3B is omitted for description brevity.

After the deriving of the first key information in optional step S1-3, in an optional step S1-4a, the generating in step S1-4 performed e.g. by the client 201 may further comprise encrypting the first client-related identity information with the derived first key information (e.g. K*_{SP}) in order to obtain the second client-related identity information (e.g. ID*).

Furthermore, in the optional step S1-9a, e.g. the client 201 may perform providing, to the SP 2021, second key information second key information (e.g. K*_{SP}) being specific for the service providing network entity and being based on the key information being a secret of the client and the identity information (e.g. SP) related to the service providing network entity. In an optional step S2-2a, e.g. the SP 2021 may perform receiving the second key information.

In addition, after the determining in step S2-3, in an optional step S2-4, e.g. the SP 2021 may perform decrypting the second client-related identity information with the second key information in order to obtain the first client-related identity information.

Then, in the optional step S2-5, e.g. the SP 2021 may perform providing, from the service providing network entity 2021, a requested customized service to the client 201 based on the first client-related identity information (e.g. ID).

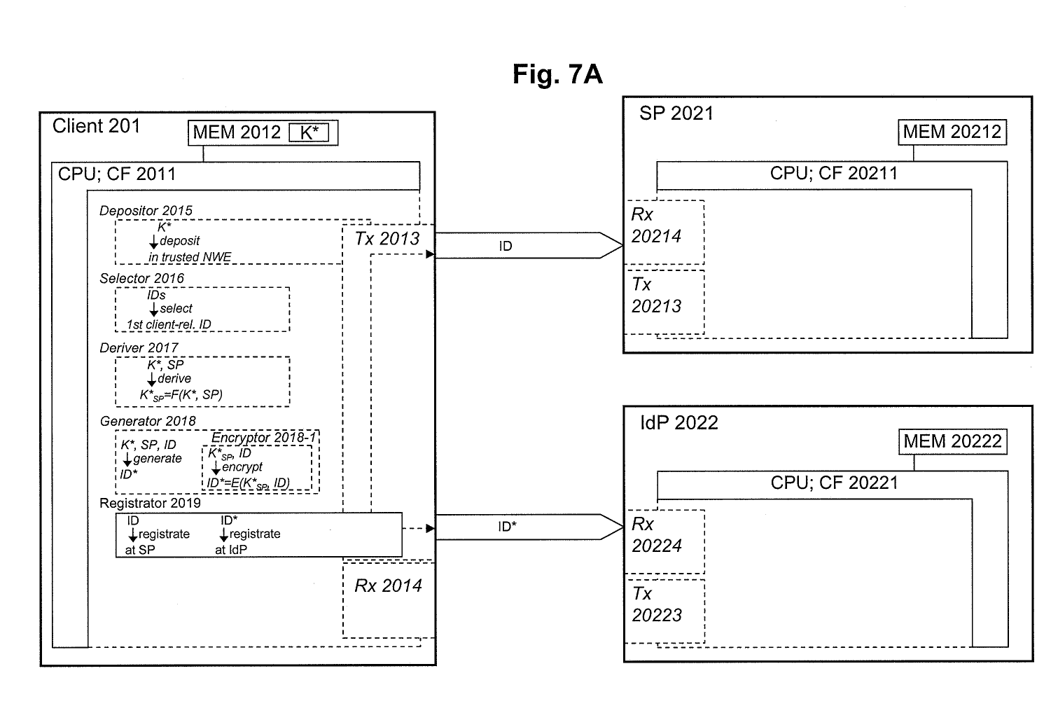

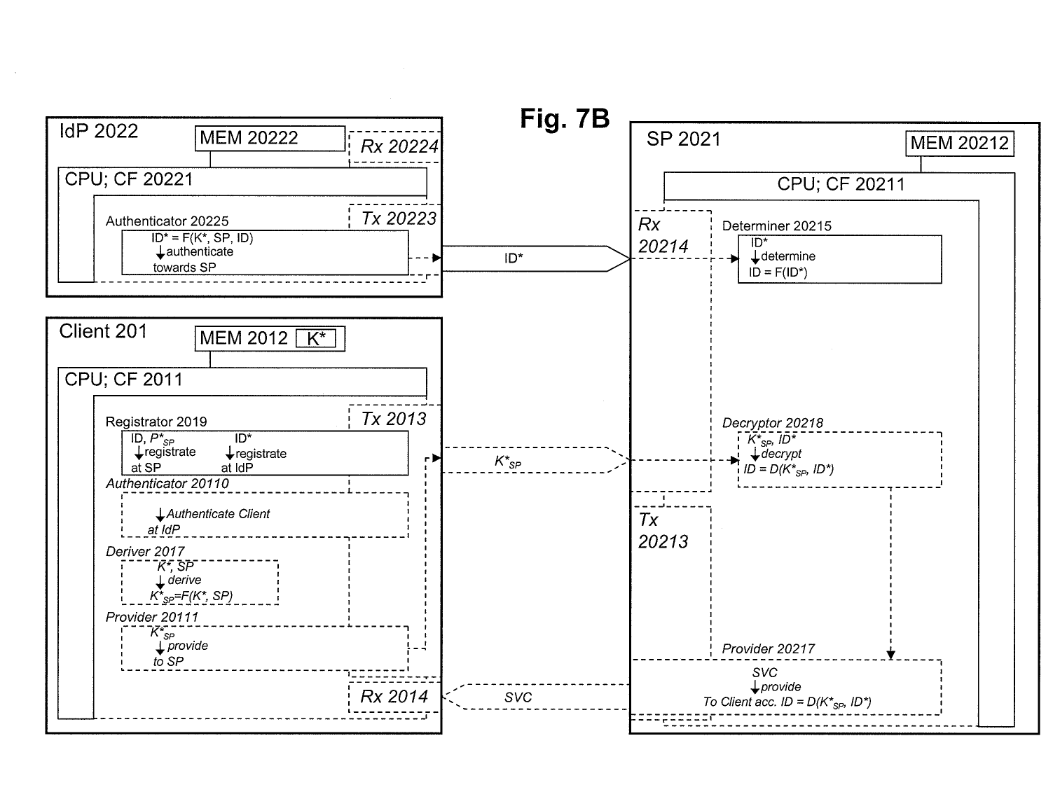

FIGS. 7A and 7B show apparatuses for privacy-enhanced identity management according to the second example of the present invention. Reference signs identical to those in FIGS. 4A and 4B designate the same or similar means or portions. Likewise, description of means identical to those shown in FIGS. 4A and 4B is omitted for description brevity.

Further, as described above, also means for encrypting 2018-1 of the client 201 and means for decrypting 20218 of the SP 2021 may be functionalities running on the CPUs 2011, 20221 of the client 201 or the SP 2021, respectively, or may alternatively be separate functional entities or means. Further, the CPUs 20x1 (wherein x=1 and 21) may respectively be configured to process various data inputs and to control the functions also of the means for encrypting 2018-1 of the client 201 and the means for decrypting 20218 of the SP 2021.

As a part of the means for generating 2018 of the client 201, e.g. the means for encrypting 2018-1 of the client may perform encrypting the first client-related identity information with the derived first key information (e.g. K*_{SP}) in order to obtain the second client-related identity information (e.g. ID*).

Furthermore, e.g. the means for providing 20111 of the client 201 may perform providing, to the SP 2021, second key information second key information (K*_{SP}) being specific for the service providing network entity and being based on the key information being a secret of the client and the identity information (e.g. SP) related to the service providing network entity. Optionally, e.g. the means for receiving 20214 of the SP 2021 may perform receiving the second key information.

In addition, after the determining performed by the means for determining 20215, e.g. the means for decrypting 20218 of the SP 2021 may perform decrypting the second client-related identity information with the second key information in order to obtain the first client-related identity information.

Then, e.g. the means for providing 20217 of the SP 2021 may perform providing, from the service providing network entity 2021, a requested customized service to the client 201 based on the first client-related identity information (e.g. ID).

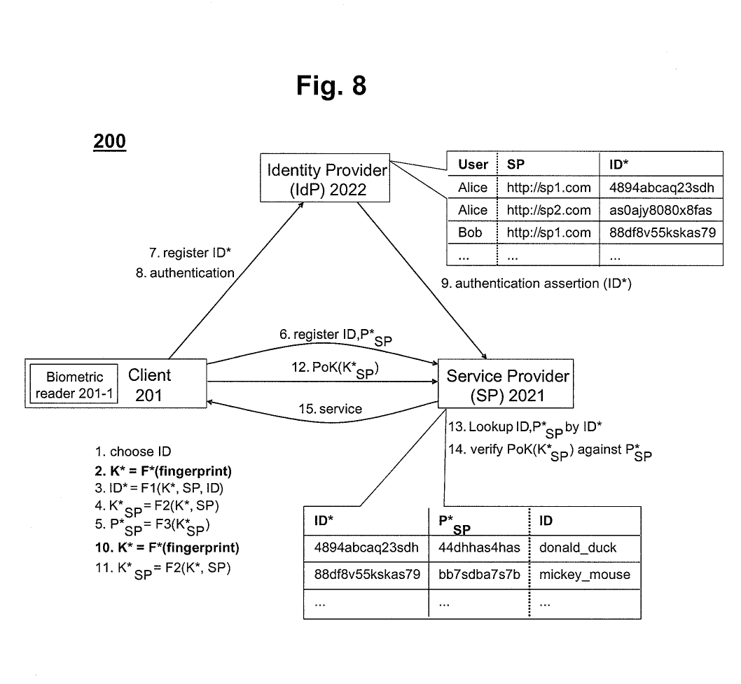

FIG. 8 shows the principle of the third example of the present invention, to which principle the present invention is not to be restricted to. Again, as shown in FIG. 8, the communication network 200 may comprise the client 201 and the core network 202 (not shown). The core network 202 may in turn comprise the SP 2021 and the IdP 2022. In addition, the client 201 may also comprise a biometric reader 201-1. It is to be noted that any reference to steps S1 to S14 refers to “1.” to “14.” in FIG. 8.

When comparing FIGS. 8 and 5, the difference is due to the newly inserted steps S2 and S10, in which the master secret K* may be generated e.g. on the fly by a cryptographic function F* (e.g. a cryptographic hash function). Execution of F* may require the user e.g. to sweep their finger over the biometric reader 201-1.

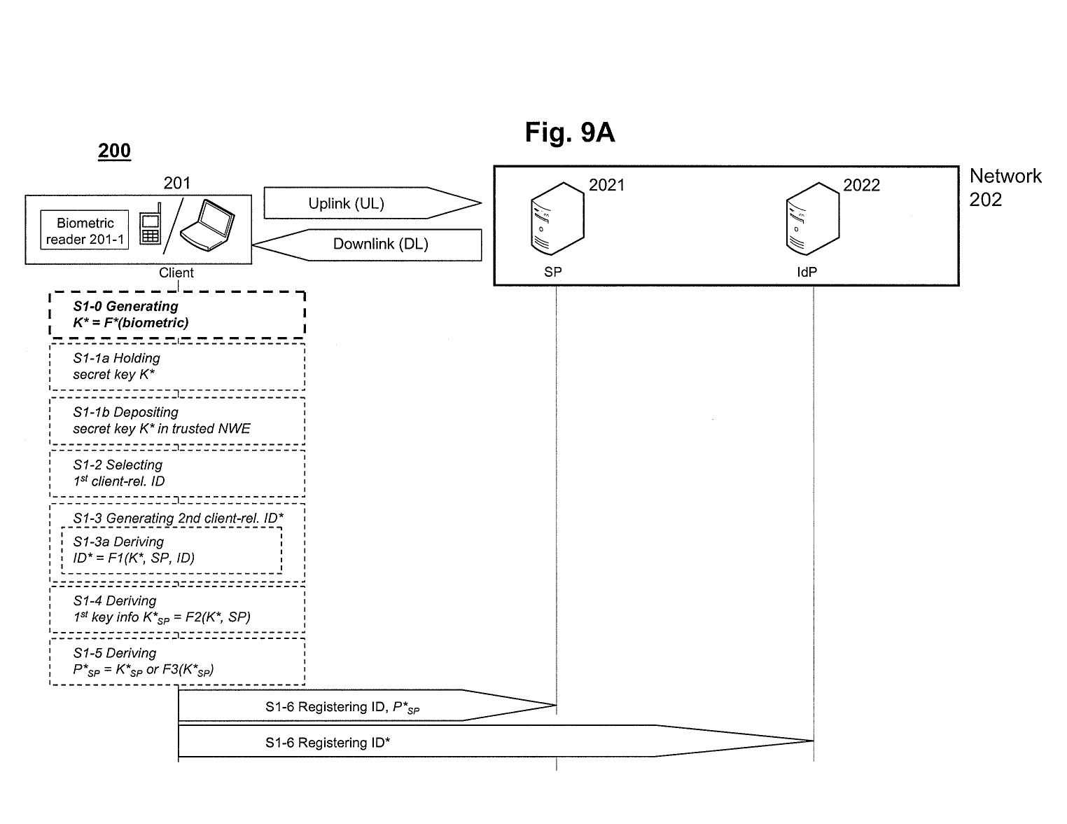

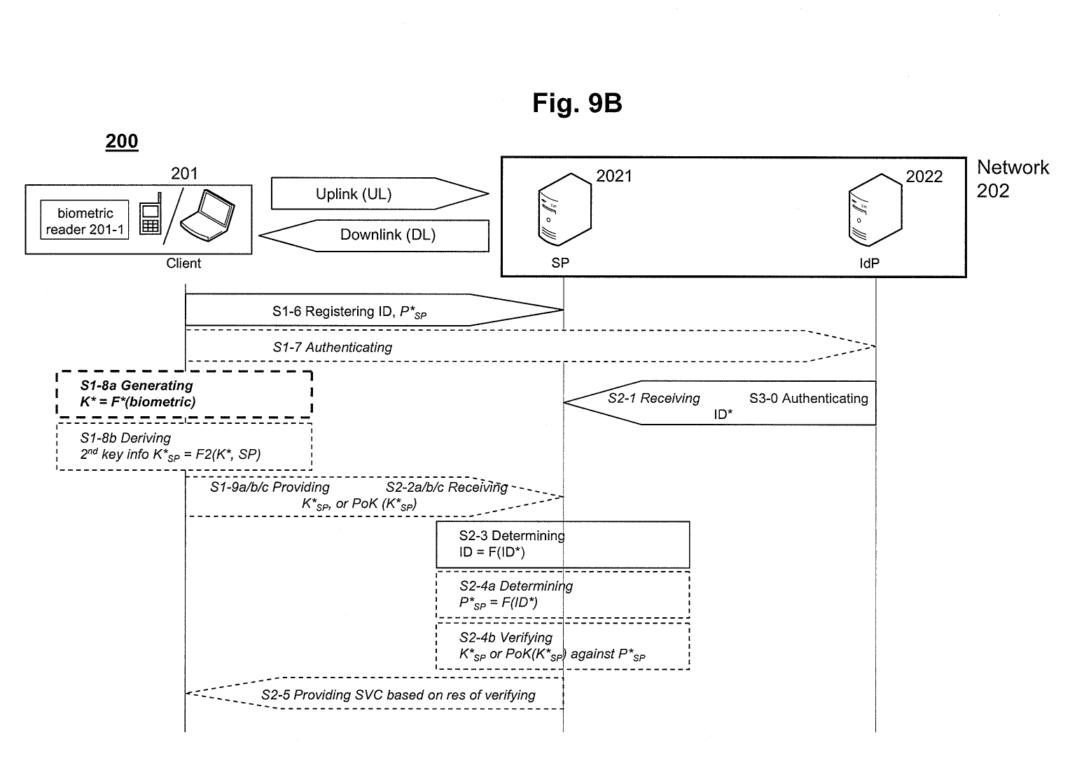

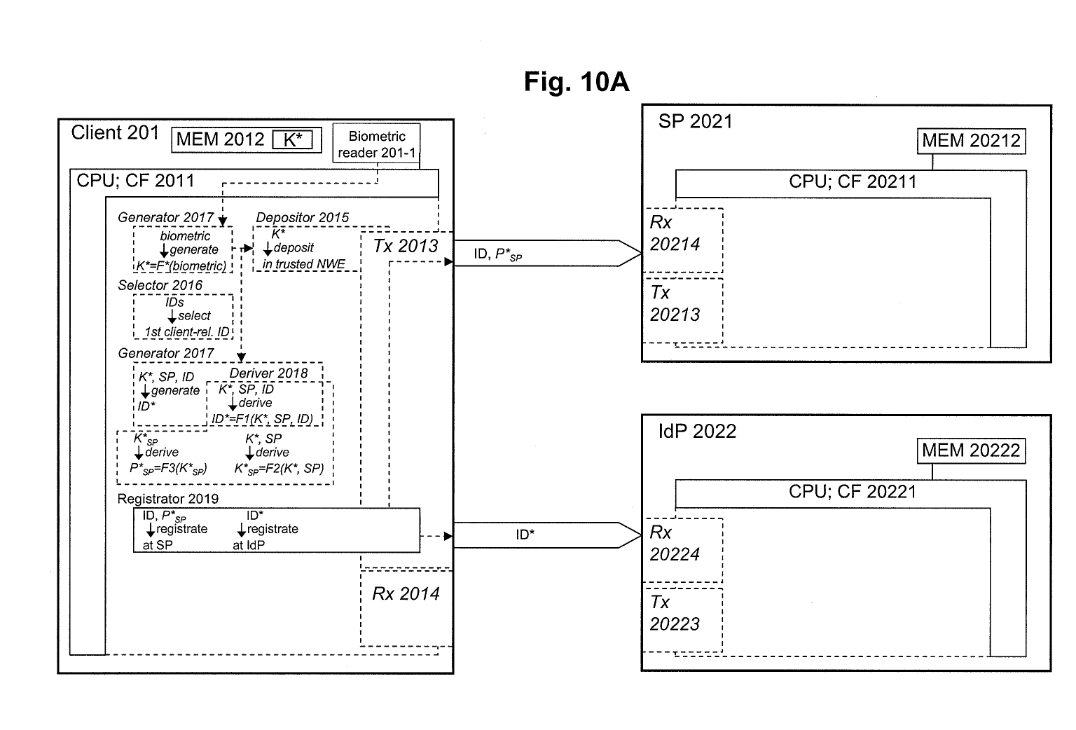

FIGS. 9A and 9B show methods for privacy-enhanced identity management according to the third example of the present invention. Reference signs identical to those in FIGS. 3A and 3B designate the same or similar means or portions. Likewise, description of steps identical to those shown in FIGS. 3A and 3B is omitted for description brevity.

E.g. prior to optional step S1-1a, in an optional step S1-0, e.g. the client 201 may perform generating the key information (e.g. K*) being a secret of the client by a cryptographic function (e.g. F*) of a biometric characteristic of a user of the client. The cryptographic function may be a cryptographic hash function.

Furthermore, in correspondence to step S1-0, in an optional step S1-8 e.g. prior to the deriving in step S1-8b, e.g. the client 201 may again perform generating the key information (e.g. K*) being a secret of the client by the cryptographic function (e.g. F*) of the biometric characteristic of the user of the client. The cryptographic function may again be a cryptographic hash function.

As for developments of the methods according to the third example of the present invention, the biometric characteristic may comprise a physiological characteristic and/or a behavioral characteristic, wherein the physiological characteristic may comprise a face, a hand, a fingerprint and/or an iris of the user, while the behavioral characteristic may comprise a signature and/or a voice of the user. Further, if the biometric characteristic is the fingerprint, the deriving may be based on a cryptographic function meeting the following criteria: i) if two different fingers are used, the key information generated from the extracted features may be different with a first probability; and ii) if the same finger is used, two key information values generated from two different finger scans may be identical with a second probability. The first probability may be 0.999999, and the second probability may be 0.99.

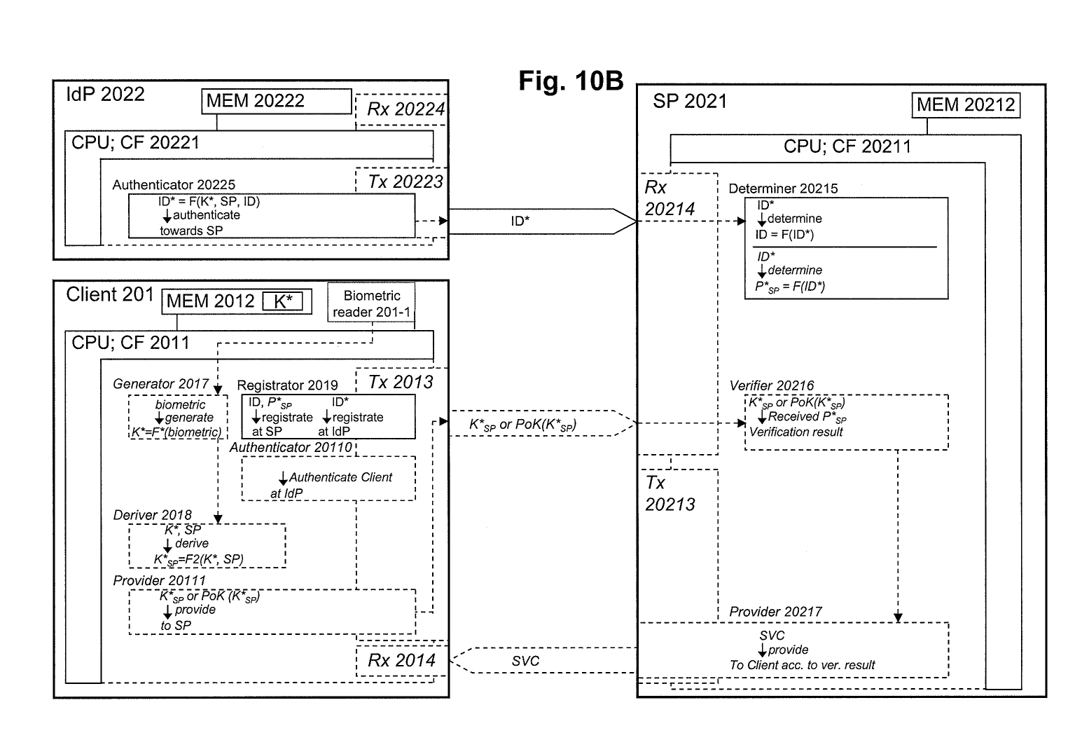

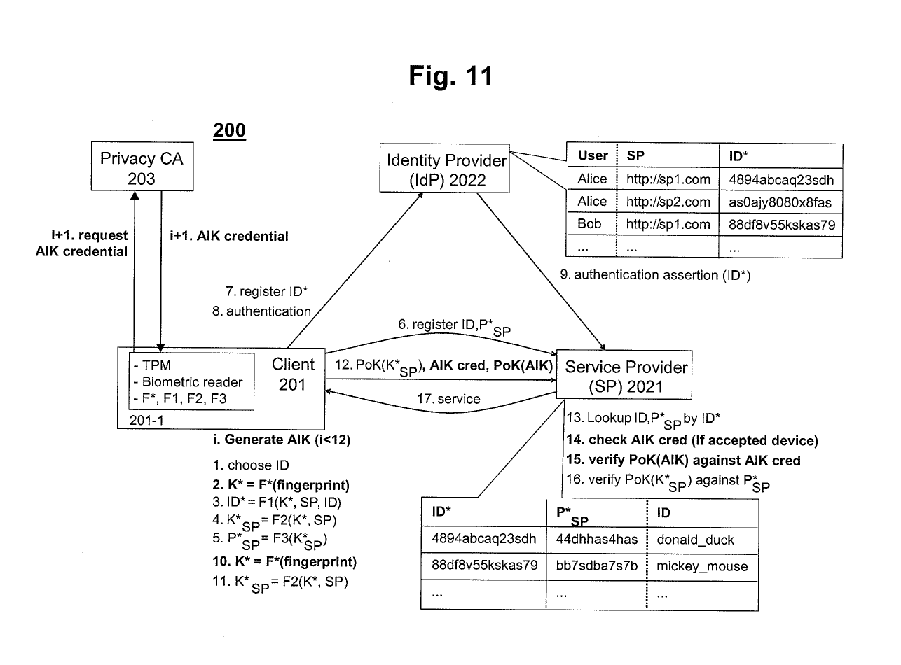

FIGS. 10A and 10B show apparatuses for privacy-enhanced identity management according to the third example of the present invention. Reference signs identical to those in FIGS. 4A and 4B designate the same or similar means or portions. Likewise, description of means identical to those shown in FIGS. 4A and 4B is omitted for description brevity.

Further, as described above, also a biometric reader 201-1 of the client 201 may be a functionality running on the CPU 2011 of the client 201 (not shown) or may alternatively be separate functional entities or means. Further, the CPU 2011 may be configured to process various data inputs and to control the functions also of the biometric reader of the client 201.

E.g. being fed by the biometric reader 201-1, e.g. the means for generating 2017 of the client 201 may perform generating the key information (e.g. K*) being a secret of the client by a cryptographic function (e.g. F*) of a biometric characteristic of a user of the client. The cryptographic function may be a cryptographic hash function.

Furthermore, e.g. prior to the deriving performed by the means for deriving in FIG. 10B, e.g. the means for generating 2017 of the client 201 may again perform generating the key information (e.g. K*) being a secret of the client by the cryptographic function (e.g. F*) of the biometric characteristic of the user of the client. The cryptographic function may again be a cryptographic hash function.

As for developments of the apparatuses according to the third example of the present invention, the biometric characteristic may comprise a physiological characteristic and/or a behavioral characteristic, wherein the physiological characteristic may comprise a face, a hand, a fingerprint and/or an iris of the user, while the behavioral characteristic may comprise a signature and/or a voice of the user. Further, if the biometric characteristic is the fingerprint, the deriving may be based on a cryptographic function meeting the following criteria: i) if two different fingers are used, the key information generated from the extracted features may be different with a first probability; and ii) if the same finger is used, two key information values generated from two different finger scans may be identical with a second probability. The first probability may be 0.999999, and the second probability may be 0.99.

FIG. 11 shows the principle of the fourth example of the present invention, to which principle the present invention is not to be restricted to. As shown in FIG. 11, the communication network 200 may comprise the client 201, the core network 202 (not shown) and a privacy certificate authority (CA) 203. The core network 202 may in turn comprise the SP 2021 and the IdP 2022. In addition, the client 201 may also comprise a trusted platform 201-1, which may comprise a trusted platform module (TPM) or similar security element, the above-mentioned biometric reader and a module for a set of cryptographic functions (e.g. F*, F1, F2 and F3). It is to be noted that any reference to steps S1 to S16 refers to “1.” to “16.” in FIG. 11.

When comparing FIGS. 11 and 8, the difference is that steps S2, S3, S4, S5, S10, S11 and S12 may be performed by the trusted platform 201-1.

Furthermore, the newly introduced steps Si, Si+1, Si+2 may be executed sometime before the attestation identity key (AIK) is used in step S12.

The AIK credential may contain the AIK public key and other information about the TPM hardware (such as platform or TPM manufacturer name, platform or TPM model number, platform or TPM version). The AIK credential may also contain a pointer to where the SP 2021 can find the conformance documentation of the trusted platform 201-1. The SP 2021 may use this information, along with other information in the credential, to check if the platform matches the requirements. In possession of the AIK credential, the client 201 can attest to platform authenticity by proving to the SP 2021 that the AIK is tied to a valid credential. So, the SP 2021 may be convinced that the master secret (e.g. K*) of the client 201 is generated by a specific trusted platform module (TPM) triggered e.g. by a finger swipe of the user (cf. e.g. steps S14 and S15).

The actual time of execution of steps Si, Si+1 and Si+2 may be left open, because there are different possibilities depending on privacy requirements and ease of use; (1) one possibility is to use the same AIK with each SP, in which case these steps may executed only once; (2) another possibility is to use a different AIK with each SP; in this case, these steps may executed together with steps S1 to S6, and the AIK may then be stored and bound to the identifier of the SP 2021 inside the trusted platform; (3) these steps are executed right before step S12, not requiring to store the AIK-SP bindings; (4) a combination of 2 and 3 in which acquiring the AIK and binding it to the SP may be executed in a “lazy” fashion, i.e. right before needed.

Step S12 may also extended with the information needed for the attestation: the AIK credential may be attached to the message, PoK (AIK) denotes the information that convinces the SP 2021 about the identity of the trusted platform 201-1 (i.e. that the AIK referred in the AIK credential really belongs to it)—in practice, this information PoK(AIK) can be a signature of the trusted platform on the information PoK(K*_{SP}), this signature being generated e.g. by means of the private key part of the AIK.

Further, step S14 may be introduced, in which the SP 2021 may check that the AIK credential sent by the party on the other end meets the requirements, e.g. it is an accepted fingerprint reader with the necessary functions F*, F1, F2, F3 built in; basically, one requirement that may be checked here is that the input taken by the function F* comes from a real finger swipe, and that the functions F*, F1, F2, F3 are executed by the trusted platform.

Finally, step 15 may be introduced, in which the SP 2021 may check that the AIK credential is really bound to the trusted platform on the other end.

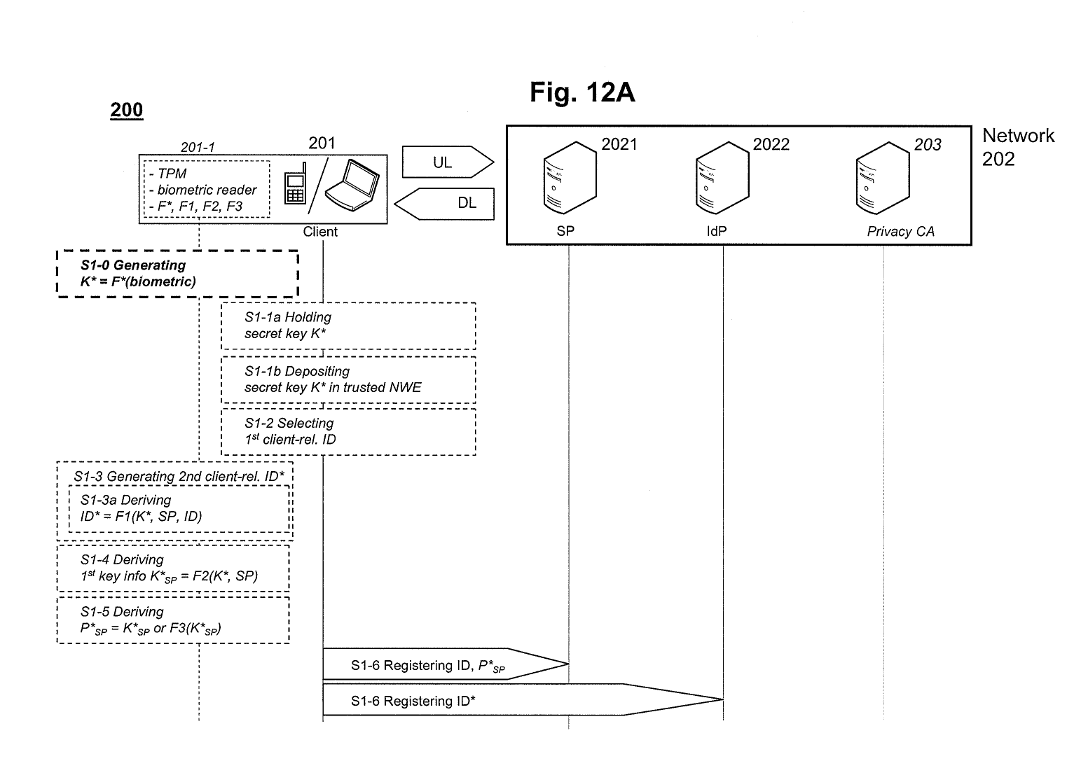

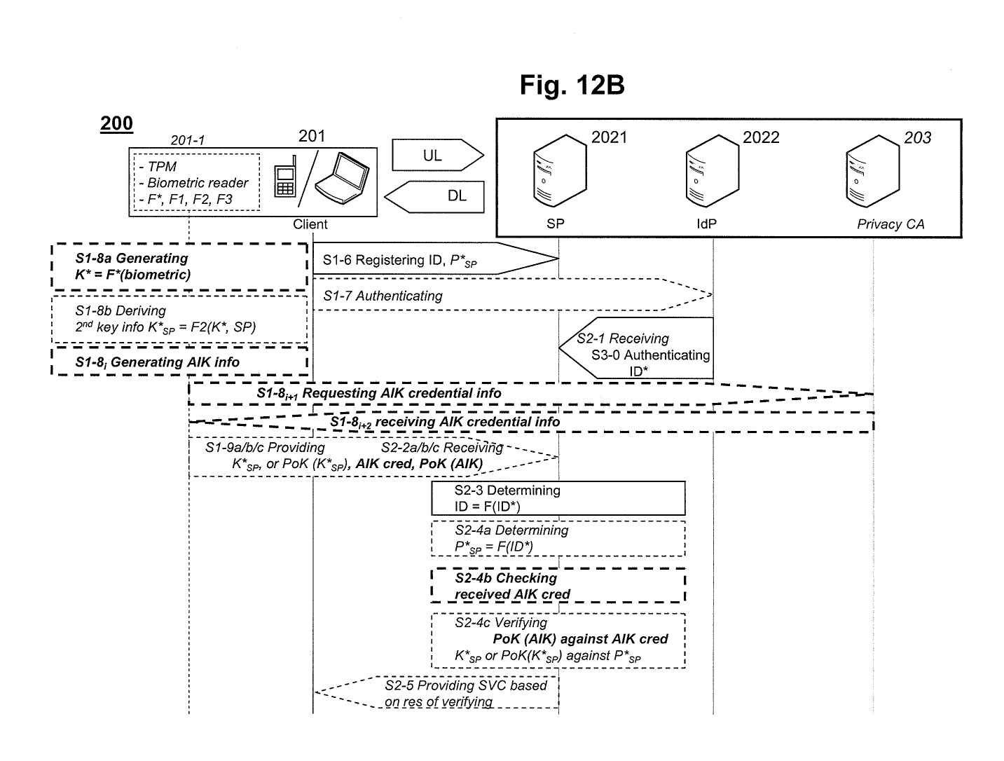

FIGS. 12A and 12B show methods for privacy-enhanced identity management according to the fourth example of the present invention. Reference signs identical to those in FIGS. 9A and 9B designate the same or similar means or portions. Likewise, description of steps identical to those shown in FIGS. 9A and 9B is omitted for description brevity.

E.g. the deriving, the providing and the generating may be performed by the trusted platform 201-1 in the client 201.

Furthermore, e.g. prior to the providing in optional step S1-9, e.g. the client 201 may perform, in an optional step S1-8, generating, at the trusted platform module, attestation key information (e.g. AIK) related to the trusted platform module, in an optional step S1-8ᵢ₊₁, requesting, at a privacy certificate authority 203, credential information in response to the attestation key information, and, in an optional step S1-8ᵢ₊₂, receiving, at the trusted platform module, the requested credential information.

As a development, the generating, the requesting and the receiving may be performed i) only once in order to use the same attestation key information for each service providing network entity; or ii) together with the selecting, the generating, deriving and the registering in order to store and bind the attestation key information to the identity information related to the service providing network entity in the trusted platform; or iii) directly prior to the providing; or iv) by a combination of ii) and iii) in order to acquire and bind the attestation key information directly prior to an arousing need for the attestation key information.

Furthermore, e.g. the trusted platform 201-1 in the client 201 may perform providing further, from the client 201 to the service providing network entity 2021, a proof of knowledge of the second key information (e.g. PoK(K*_{SP})), the credential information and/or a proof of knowledge of the credential information.

In addition, e.g. the SP 2021 may perform, in the optional step S2-4a, determining a shared secret (e.g. P*_{SP}) based on the second client-related identity information, in an optional step S2-4b, checking received credential information (e.g. AIK), and, in the optional step S2-4c, verifying a received proof of knowledge of credential information against the credential information, and a received proof of knowledge of the shared secret against the determined shared secret.

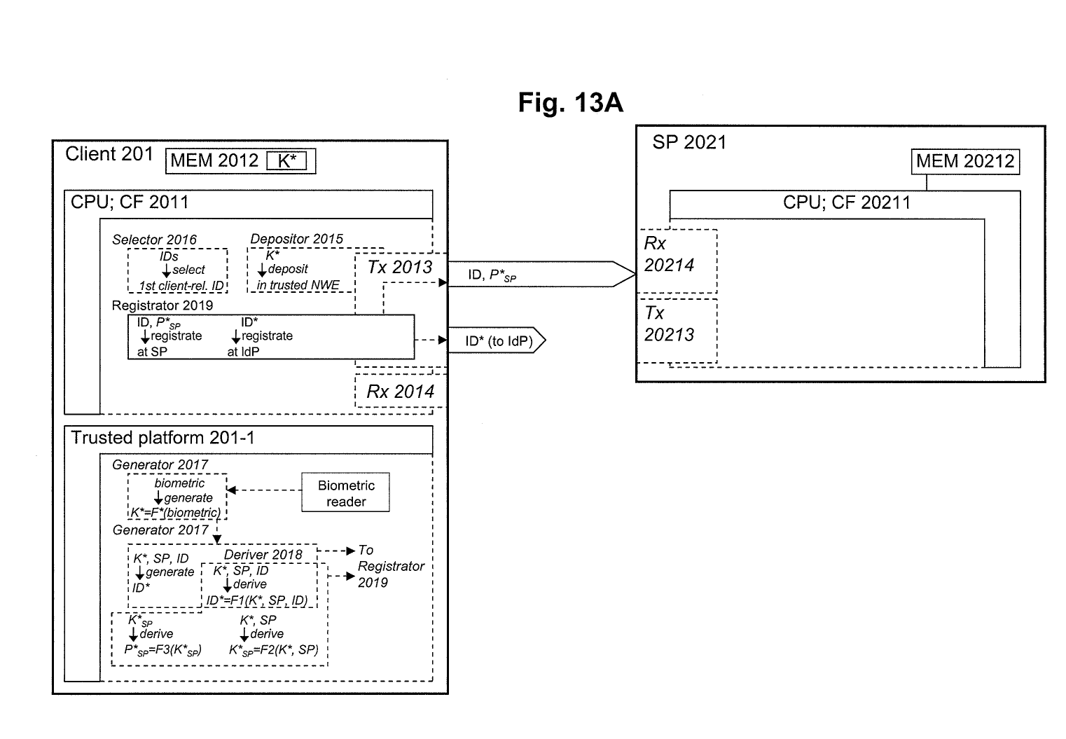

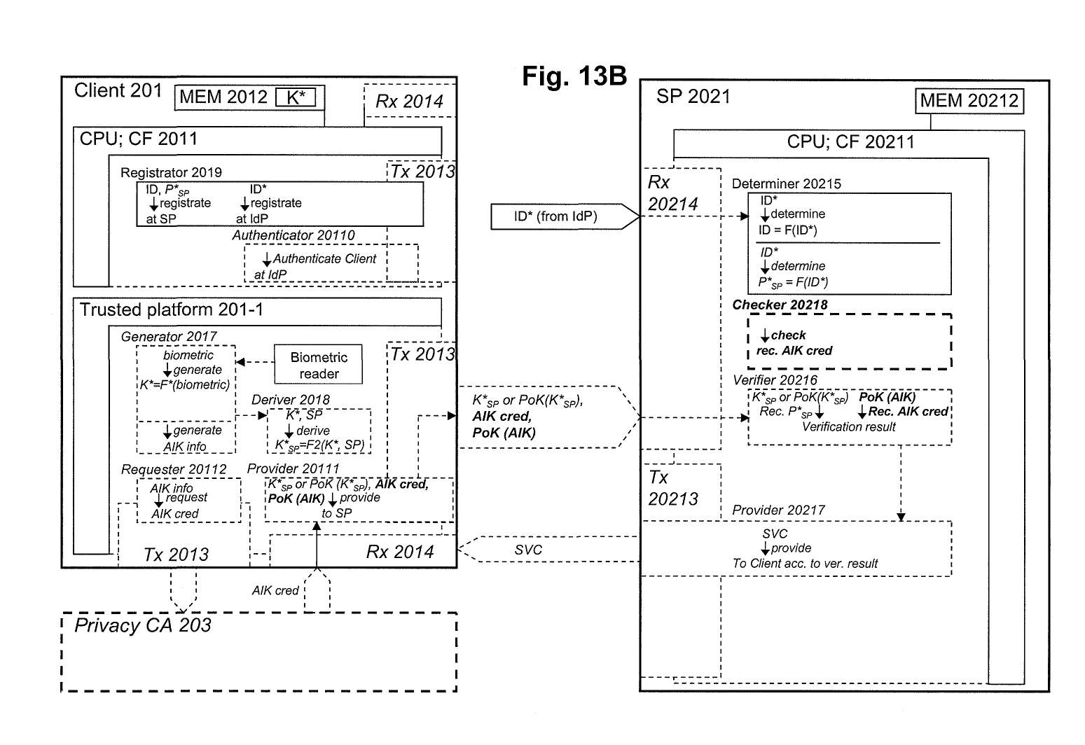

FIGS. 13A and 13B show apparatuses for privacy-enhanced identity management according to the fourth example of the present invention. Reference signs identical to those in FIGS. 10A and 10B designate the same or similar means or portions. Likewise, description of means identical to those shown in FIGS. 10A and 10B is omitted for description brevity.

Further, as described above, also the trusted platform 201-1 of the client 201 and the means for checking 20219 of the SP 2021 may be functionalities running on the CPUs 2011 or 20211 of the client 201 or the SP 2021, respectively, or may alternatively be separate functional entities or means. Further, the CPUs 2011, 20211 may be configured to process various data inputs and to control the functions also of the trusted platform 201-1 of the client 201 and the means for checking 20219. Furthermore, as shown in FIGS. 13A and 13B, the means for generating 2017, the means for deriving 2018, the means for requesting 20112, the means for transmitting 2013 and the means for receiving 2014 may also be functionalities running on or be used by the trusted platform 201-1 or similar entity (e.g. smart card).

As mentioned above, e.g. the means for deriving 2017, the means for providing 20111 and the means for generating may be comprised in the trusted platform 201-1 in the client 201.

Furthermore, e.g. the means for generating 2017 of the client 201 or trusted platform 201-1 may perform generating, at the trusted platform module, attestation key information (e.g. AIK) related to the trusted platform module. For example, the means for requesting 20112 of the client 201 or trusted platform 201-1 may perform requesting, at a privacy certificate authority 203, credential information in response to the attestation key information. And, e.g. the means for receiving 2014 of the client 201 or trusted platform 201-1 may perform receiving, at the trusted platform module, the requested credential information.

As a development, the means for generating, the means for requesting and the means for receiving may be configured to perform i) only once in order to use the same attestation key information for each service providing network entity; or ii) together with the selecting, the generating, deriving and the registering in order to store and bind the attestation key information to the identity information related to the service providing network entity in the trusted platform; or iii) directly prior to the providing; or iv) by a combination of ii) and iii) in order to acquire and bind the attestation key information directly prior to an arousing need for the attestation key information.

Furthermore, e.g. the means for providing 20111 of the trusted platform 201-1 or the client 201 may perform providing further, from the client 201 to the service providing network entity 2021, a proof of knowledge of the second key information (e.g. PoK(K*_{SP})), the credential information and/or a proof of knowledge of the credential information.

In addition, e.g. the means for determining 20215 of the SP 2021 may perform determining a shared secret (e.g. P*_{SP}) based on the second client-related identity information. Further, e.g. the means for checking 20219 of the SP 2021 may perform checking received credential information (e.g. AIK). And, e.g. the means for verifying 20216 may additionally perform verifying a received proof of knowledge of credential information against the credential information, and a received proof of knowledge of the shared secret against the determined shared secret.

Furthermore, at least one of, or more of the above-described means for registering, means for deriving, means for encrypting, means for selecting, means for holding, means for depositing, means for generating, means for authenticating, means for providing, means for requesting, means for receiving, means for determining, means for verifying, means for decrypting as well as the client 201, the SP 2021 and/or the IdP 2022, or the respective functionalities carried out, may be implemented as a chipset or module.

Finally, the present invention also relates to a system which may comprise client 201, the SP 2021 and the IdP 2022 according to the above-described first to fourth examples of the present invention.

Without being restricted to the details following in this section, the embodiment of the present invention may be summarized as follows:

### A) Base Idea

The base idea is the following. The SP-specific user ID—i.e. the Client's account identifier at the SP (e.g. donald_duck)—is never registered at the IdP in a cleartext form; instead, another identifier denoted by ID* is registered at the IdP as the Client's identifier to the SP. Hence the IdP will include ID* into the authentication assertion. The SP and the Client further collaborate for figuring out the actual identifier ID.
In other words, we have introduced a shared secret—let's call it K*_{SP}—between the Client and the SP. This secret is not known to the IdP so—by requiring a proof of knowledge of K*_{SP} from the Client by the SP—it is guaranteed that the IdP can not impersonate the client. This newly introduced shared secret must be different for each SP; this mitigates the threat that an SP and an IdP might otherwise collude to impersonate the Client.
To prevent the Client from the burden of storing a different shared secret K*_{SP} for each SP, it is a more economic approach to introduce a single master secret K* that is only possessed by the Client and is never disclosed to anyone else, and then to derive all the K*_{SP} values from the master secret K*.
There may be many variations on the same theme, as to e.g.:

how the opaque identifier ID* is generated by the Client (the cryptographic function F1 is not further specified: is it an encryption function or a cryptographic hash function),

whether K*_{SP} is used as a secret key, or it is directly used as a shared secret between the Client and the SP, or the authentication between the Client and the SP is carried out by some other means (e.g. by incorporating biometric identification),

how the proof of knowledge of K*_{SP} is carried out (steps S10 and S12); there is suggested a challenge-response type of proof-of-knowledge algorithm, like the ones used for PKI certificates; one method is to simply send the SP-specific shared secret (P*_{SP}=K*_{SP}) to the SP in step 10, or another version of this latter shared secret-based variant involves digest authentication of the Client by the SP on the basis of the shared secret,

how the Client recovers from the case of device loss (another possibility for the Client, compared to the method described above, would be to deposit the master key K* at a trusted “fourth party”).

### B) Decryption by the SP

This case is a variation of the base idea, where the SP-specific key K*_{SP} is used as a symmetric encryption/decryption key. The key is used by the Client for encrypting the ID before registering it at the IdP, and by the SP for decrypting the ID* received from the IdP. The decryption key is sent by the Client to the SP at each authentication, so there is no need for a database on the SP's side.

### C) Proof of Biometrics

The motivation for introducing biometrics is to avoid the need for the Client to store the master secret (K*) on the device. Instead of storing it on the device, K* is generated from the Client's biometrics each time it is needed. Then in case of device loss, it is easier to recover as there is no need to register a new ID* at the IdP and P*_{SP} at the SP: the Client can just buy a new device and the authentication flow can continue without a break.
D) Proof of Biometrics with a TPM
To enforce that the execution of F* really require a finger swipe, F* is executed on a trusted platform. This trusted platform consists of the following modules:

a TPM (Trusted Platform Module) in the terminology of TCG,

a fingerprint reader,

a module that executes the functions F*, F1, F2 and F3.

The modules are assembled together in a tamper-resistant way (forming a trust boundary in TCG terminology)

### Further Examples

For the purpose of the present invention as described herein above, it should be noted that

an access technology may be any technology by means of which a user equipment can access an access network (or base station, respectively). Any present or future technology, such as WiMAX (Worldwide Interoperability for Microwave Access) or WLAN (Wireless Local Access Network), BlueTooth, Infrared, and the like may be used; although the above technologies are mostly wireless access technologies, e.g. in different radio spectra, access technology in the sense of the present invention may also imply wirebound technologies, e.g. IP based access technologies like cable networks or fixed line.

a network may be any device, unit or means by which a station entity or other user equipment may connect to and/or utilize services offered by the access network; such services include, among others, data and/or (audio-) visual communication, data download etc.;

generally, the present invention may be applicable in those network/user equipment environments relying on a data packet based transmission scheme according to which data are transmitted in data packets and which are, for example, based on the Internet Protocol IP. The present invention is, however, not limited thereto, and any other present or future IP or mobile IP (MIP) version, or, more generally, a protocol following similar principles as (M)IPv4/6, is also applicable, e.g. UDP (user datagram protocol);

a user equipment may be any device, unit or means by which a system user may experience services from an access network;

method steps likely to be implemented as software code portions and being run using a processor at a network element or terminal (as examples of devices, apparatuses and/or modules thereof, or as examples of entities including apparatuses and/or modules therefore), are software code independent and can be specified using any known or future developed programming language as long as the functionality defined by the method steps is preserved;

generally, any method step is suitable to be implemented as software or by hardware without changing the idea of the invention in terms of the functionality implemented;

method steps and/or devices, units or means likely to be implemented as hardware components at the above-defined apparatuses, or any module(s) thereof, are hardware independent and can be implemented using any known or future developed hardware technology or any hybrids of these, such as MOS (Metal Oxide Semiconductor), CMOS (Complementary MOS), BiMOS (Bipolar MOS), BiCMOS (Bipolar CMOS), ECL (Emitter Coupled Logic), TTL (Transistor-Transistor Logic), etc., using for example ASIC (Application Specific IC (Integrated Circuit)) components, FPGA (Field-programmable Gate Arrays) components, CPLD (Complex Programmable Logic Device) components or DSP (Digital Signal Processor) components; in addition, any method steps and/or devices, units or means likely to be implemented as software components may alternatively be based on any security architecture capable e.g. of authentication, authorization, keying and/or traffic protection;

devices, units or means (e.g. the above-defined apparatuses, or any one of their respective means) can be implemented as individual devices, units or means, but this does not exclude that they are implemented in a distributed fashion throughout the system, as long as the functionality of the device, unit or means is preserved;

an apparatus may be represented by a semiconductor chip, a chipset, or a (hardware) module comprising such chip or chipset; this, however, does not exclude the possibility that a functionality of an apparatus or module, instead of being hardware implemented, be implemented as software in a (software) module such as a computer program or a computer program product comprising executable software code portions for execution/being run on a processor;

a device may be regarded as an apparatus or as an assembly of more than one apparatus, whether functionally in cooperation with each other or functionally independently of each other but in a same device housing, for example.

Although the present invention has been described herein before with reference to particular embodiments thereof, the present invention is not limited thereto and various modification can be made thereto.

1-47. (canceled)

48. A method, which comprises the steps of:
registering, from a client at a service providing network entity, first client-related identity information; and
registering, from the client at an identity providing network entity, second client-related identity information being different from the first client-related identity information and being generated based on the first client-related identity information, and key information being a secret of the client and identity information being related to the service providing network entity.

49. The method according to claim 48, which further comprises:
deriving one of a shared secret between the client and the service providing network entity or a proof of knowledge of the shared secret; and
wherein the registering, from the client to service providing network entity, further includes one of the shared secret between the client and the service providing network entity or the proof of knowledge of the shared secret.

50. The method according to claim 49, which further comprises deriving first key information being specific for the service providing network entity and being based on the key information being the secret of the client and the identity information related to the service providing network entity.

51. The method according to claim 50, which further comprises generating the second client-related identity information.

52. The method according to claim 51, wherein the generating step further comprises deriving the second client-related identity information based on the first client-related identity information, the key information being the secret of the client and the identity information is related to the service providing network entity.

53. The method according to claim 52, wherein the deriving step is based on one of an encryption function or a cryptographic hash function.

54. The method according to claim 51, wherein the generating step further comprises encrypting the first client-related identity information with the first key information derived to obtain the second client-related identity information.

55. The method according to claim 53, which further comprises selecting the first client-related identity information.

56. The method according to claim 55, which further comprises holding, in the client, the key information being the secret of the client.

57. The method according to claim 56, which further comprises depositing the key information being the secret of the client in a trusted network entity.

58. The method according to claim 57, which further comprises generating the key information being the secret of the client by a cryptographic function of a biometric characteristic of a user of the client.

59. The method according to claim 58, wherein the cryptographic function is a cryptographic hash function.

60. The method according to claim 58, wherein at least one of the registering steps, the deriving step, the encryption function, the selecting step, the holding step, the depositing step and the generating step is performed once per existing first client-related identity information and once per loss of the client.

61. The method according to claim 48, which further comprises authenticating the client at the identity providing network entity.

62. The method according to claim 61, which further comprises deriving second key information being specific for the service providing network entity and being based on the key information being the secret of the client and the identity information related to the service providing network entity.

63. The method according to claim 62, which further comprises providing, from the client to the service providing network entity, the second key information as the shared secret between the client and the service providing entity.

64. The method according to claim 63, which further comprises providing, from the client to the service providing network entity, a proof of knowledge of the second key information.

65. The method according to claim 64, which further comprises providing, from the client to the service providing network entity, a digest authentication of the client by the service providing network entity.

66. The method according to claims 65, which further comprises generating the key information being the secret of the client by a cryptographic function of a biometric characteristic of a user of the client.

67. The method according to claim 66, wherein the cryptographic function is a cryptographic hash function.

68. The method according to claim 66, which further comprises performing the deriving step, the providing step and the generating step via a trusted platform in the client.

69. The method according to claim 66, which further comprises, prior to the providing step:
generating, at a trusted platform module, attestation key information related to the trusted platform module;
requesting, at a privacy certificate authority, credential information in response to the attestation key information; and
receiving, at the trusted platform module, the requested credential information.

70. The method according to claim 69, wherein the generating step, the requesting step and the receiving step of claim 69 are performed:
i) only once in order to use the same attestation key information for each service providing network entity;
ii) together with the selecting, the generating step, the deriving step and the registering step in order to store and bind the attestation key information to the identity information related to the service providing network entity in the trusted platform;
iii) directly prior to the providing step; or
iv) by a combination of ii) and iii) in order to acquire and bind the attestation key information directly prior to an arousing need for the attestation key information.

71. The method according to claim 69 wherein the providing step further provides, from the client to the service providing network entity, at least one a proof of knowledge of the second key information, the credential information and a proof of knowledge of the credential information.

72. The method according to claim 69, wherein at least one of the authenticating step, the deriving step, the providing step, the generating step, the requesting step or the receiving step is performed each time the client is authenticated by a service providing entity.

73. A method, which comprises the step of:
determining, at a service providing network entity, first client-related identity information based on second client-related identity information received from an identity providing entity, being different from the first client-related identity information and being based on the first client-related identity information, key information being a secret of a client and identity information related to the service providing network entity.

74. The method according to claim 73, which further comprises performing the determining step once per existing first client-related identity information and once per loss of the client.

75. The method according to claim 74, which further comprises receiving, from the client at the service providing network entity, a shared secret between the client and the service providing network entity.

76. The method according to claim 75, which further comprises receiving, from the client at the service providing network entity, a proof of knowledge of second key information being specific for the service providing network entity and being based on the key information being the secret of the client and the identity information related to the service providing network entity.

77. The method according to claim 76, which further comprises receiving, from the client at the service providing network entity, a digest authentication of the client by the service providing network entity.

78. The method according to claim 77, which further comprises receiving, from the client at the service providing network entity, second key information being specific for the service providing network entity and being based on the key information being the secret of the client and the identity information related to the service providing network entity.

79. The method according to claim 78, which further comprises receiving, from the identity providing entity, the second client-related identity information.

80. The method according to claim 79, which further comprises:
determining one of a shared secret, a proof of knowledge or a digest authentication based on the second client-related identity information; and
verifying one of the shared secret received, the proof of knowledge received and the digest authentication received against a corresponding one of the shared secret determined, the proof of knowledge determined or the digest authentication determined based on the second client-related identity information.

81. The method according to claim 80, which further comprises:
determining a shared secret based on the second client-related identity information;
checking received credential information; and
verifying a received proof of knowledge of credential information against the received credential information, and a received proof of knowledge of the shared secret against the shared secret determined.

82. The method according to claim 81, which further comprises decrypting the second client-related identity information with the second key information in order to obtain the first client-related identity information.

83. The method according to claim 82, which further comprises providing, from the service providing network entity, a requested customized service to the client based on a result of verifying.

84. The method according to claim 83, which further comprises providing, from the service providing network entity, a requested customized service to the client based on the first client-related identity information.

85. The method according to claim 84, which further comprises performing at least one of the receiving steps, the determining step, the verifying step, the decrypting step or the providing step each time the client is authenticated by the service providing network entity.

86. A method, which comprises the step of:
authenticating, towards a service providing network entity, second client-related identity information being received from a client, being different from first client-related identity information and being based on the first client-related identity information, key information being a secret of a client and identity information related to the service providing network entity.

87. The method according to claim 69, wherein at least one of the following applies:
the first client-related identity information is constituted by a user account at the service providing network entity;
the deriving is based on a cryptographic function;
the cryptographic function contains at least one of deriving, public and/or private key functions, hash functions, one-way functions and symmetric encryption schemes;
the encrypting and decrypting is based on a symmetric encryption and decryption key;
the identity information related to the service providing network entity is constituted by a home uniform resource locator;
the credential information contains an attestation key identifier public key and additional information relating to trusted platform module hardware;
the additional information comprises at least one of a platform or trusted platform module manufacturer name, a platform or trusted platform module model number and a platform or trusted platform module version;
the credential information contains a pointer configured to point the service providing network entity to conformance documentation of the trusted platform in order to check whether the platform matches set requirements;
the biometric characteristic comprises at least one of a physiological characteristic and a behavioral characteristic;
the physiological characteristic comprises at least one of a face, a hand, a fingerprint and an iris of the user;
the behavioral characteristic comprises at least one of a signature and a voice of the user;
if the biometric characteristic is a fingerprint, the deriving is based on a cryptographic function meeting the following criteria:
i) if two different fingers are used, the key information generated from the extracted features are different with a first probability; and
ii) if the same finger is used, two key information values generated from two different finger scans are identical with a second probability;
the first probability is 0.999999; and
the second probability is 0.99.

88. An apparatus, comprising:
means for registering, from a client at a service providing network entity, first client-related identity information and, from the client at an identity providing network entity, second client-related identity information being different from the first client-related identity information and being generated based on the first client-related identity information, key information being a secret of the client and identity information related to the service providing network entity.

89. The apparatus according to claim 88, further comprising:
a trusted platform having modules selected from the group consisting of a trusted platform module, a finger print reader module, and a module for executing cryptographic functions required for deriving, said modules being assembled tamper-proof modules forming a boundary;
a subscriber identity module card reading module; and
a universal serial bus stick, said finger print reading module and said subscriber identity module card reading module are contained in said universal serial bus stick.

90. The apparatus according to claim 88, further comprising at least one of means for registering, means for deriving, means for encrypting, means for selecting, means for holding, means for depositing, means for generating, means for authenticating, means for providing, means for requesting, means for receiving, means for determining, means for verifying, or means for decrypting.

91. The apparatus according to claim 88, wherein the apparatus is selected from the group consisting of chipsets and modules.

92. An apparatus, comprising:
means for determining, at a service providing network entity, first client-related identity information based on second client-related identity information being received from an identity providing entity, being different from the first client-related identity information and being based on the first client-related identity information, key information being a secret of a client and identity information related to the service providing network entity.

93. The apparatus according to claim 92, further comprising:
a trusted platform having modules selected from the group consisting of a trusted platform module, a finger print reader module, and a module for executing cryptographic functions required for deriving, said modules being assembled tamper-proof modules forming a boundary;
a subscriber identity module card reading module; and
a universal serial bus stick, said finger print reading module and said subscriber identity module card reading module are contained in said universal serial bus stick.

94. The apparatus according to claim 92, further comprising at least one of means for registering, means for deriving, means for encrypting, means for selecting, means for holding, means for depositing, means for generating, means for authenticating, means for providing, means for requesting, means for receiving, means for determining, means for verifying, or means for decrypting.

95. The apparatus according to claim 92, wherein the apparatus selected from the group consisting of chipsets and modules.

96. An apparatus, comprising:
means for authenticating, towards a service providing network entity, second client-related identity information being received from a client, being different from first client-related identity information and being based on the first client-related identity information, key information being a secret of a client and identity information related to the service providing network entity.

97. The apparatus according to claim 96, further comprising:
a trusted platform having modules selected from the group consisting of a trusted platform module, a finger print reader module, and a module for executing cryptographic functions required for deriving, said modules being assembled tamper-proof modules forming a boundary;
a subscriber identity module card reading module; and
a universal serial bus stick, said finger print reading module and said subscriber identity module card reading module are contained in said universal serial bus stick.

98. The apparatus according to claim 96, further comprising at least one of means for registering, means for deriving, means for encrypting, means for selecting, means for holding, means for depositing, means for generating, means for authenticating, means for providing, means for requesting, means for receiving, means for determining, means for verifying, or means for decrypting.

99. The apparatus according to claim 96, wherein the apparatus is selected from the group consisting of chipsets and modules.

100. A system, comprising:
a first apparatus selected from the group consisting of chipsets and modules, said first apparatus containing:
first means for registering, from a client at a service providing network entity, first client-related identity information and, from the client at an identity providing network entity, second client-related identity information being different from the first client-related identity information and being generated based on the first client-related identity information, key information being a secret of the client and identity information related to the service providing network entity;
a first trusted platform having modules selected from the group consisting of a first trusted platform module, a first finger print reader module, and a first module for executing cryptographic functions required for deriving, said modules being assembled first tamper-proof modules forming a boundary;
a first subscriber identity module card reading module;
a first universal serial bus stick, said first finger print reading module and said first subscriber identity module card reading module are contained in said first universal serial bus stick;
at least one of first means for registering, first means for deriving, first means for encrypting, first means for selecting, first means for holding, first means for depositing, first means for generating, first means for authenticating, first means for providing, first means for requesting, first means for receiving, first means for determining, first means for verifying, or first means for decrypting;
a second apparatus selected from the group consisting of chipsets and modules, said second apparatus containing:
means for determining, at the service providing network entity, the first client-related identity information based on the second client-related identity information being received from the identity providing entity, being different from the first client-related identity information and being based on the first client-related identity information, the key information being the secret of the client and the identity information related to the service providing network entity;
a second trusted platform having modules selected from the group consisting of a second trusted platform module, a second finger print reader module, and a second module for executing cryptographic functions required for deriving, said modules being assembled second tamper-proof modules forming a boundary;
a second subscriber identity module card reading module;
a second universal serial bus stick, said second finger print reading module and said second subscriber identity module card reading module are contained in said second universal serial bus stick; and
at least one of second means for registering, second means for deriving, second means for encrypting, second means for selecting, second means for holding, second means for depositing, second means for generating, second means for authenticating, second means for providing, second means for requesting, second means for receiving, second means for determining, second means for verifying, or second means for decrypting;
a third apparatus selected from the group consisting of chipsets and modules, said third apparatus containing:
means for authenticating, towards the service providing network entity, the second client-related identity information being received from the client, being different from the first client-related identity information and being based on the first client-related identity information, the key information being the secret of the client and the identity information related to the service providing network entity;
a third trusted platform having modules selected from the group consisting of a third trusted platform module, a third finger print reader module, and a third module for executing cryptographic functions required for deriving, said modules being assembled third tamper-proof modules forming a boundary;
a third subscriber identity module card reading module;
a third universal serial bus stick, said third finger print reading module and said third subscriber identity module card reading module are contained in said third universal serial bus stick; and
at least one of third means for registering, third means for deriving, third means for encrypting, third means for selecting, third means for holding, third means for depositing, third means for generating, third means for authenticating, third means for providing, third means for requesting, third means for receiving, third means for determining, third means for verifying, or third means for decrypting.

101. A computer-readable medium having computer-executable instructions running on a processing means for performing a method comprising:
registering, from a client at a service providing network entity, first client-related identity information; and
registering, from the client at an identity providing network entity, second client-related identity information being different from the first client-related identity information and being generated based on the first client-related identity information, and key information being a secret of the client and identity information being related to the service providing network entity.
